(19) United States
(12) Patent Application Publication
(10) Pub. No.: US 2005/0116886 A1
(43) Pub. Date: Jun. 2, 2005

(54) Driving method of plasma display panel and plasma display device

(76) Inventors: Jae-Seok Jeong, Suwon-si (KR); Jun-Young Lee, Suwon-si (KR); Nam-Sung Jung, Suwon-si (KR)

Correspondence Address: MCGUIREWOODS, LLP, 1750 TYSONS BLVD, SUITE 1800, MCLEAN, VA, 22102, US

(21) Appl. No.: 10/948,179

(22) Filed: Sep. 24, 2004

(30) Foreign Application Priority Data
Nov. 27, 2003 (KR) 10-2003-0085115

(51) Int. Cl. G09G 3/28

(52) U.S. Cl. 345/60

(57) ABSTRACT

In an address driving circuit including a power recovery circuit, an energy charged in an external capacitor is established to be greater than an energy discharged from the external capacitor. As a result, a voltage of the external capacitor is increased to an address voltage to automatically stop a power recovery operation in a pattern having few switching variations. Further, the voltage of the external capacitor reaches an equilibrium state between half the address voltage and the address voltage to perform the power recovery operation in a pattern having many switching variations. In addition, the controller can stop the power recovery operation in a pattern having few switching variations such as the full white pattern.

### CROSS REFERENCE TO RELATED APPLICATION

This application claims priority to and the benefit of Korea Patent Application No. 2003-85115, filed on Nov. 27, 2003 in the Korean Intellectual Property Office, the content of which is incorporated herein by reference.

### BACKGROUND OF THE INVENTION

(a) Field of the Invention

The present invention relates to a driving method of a plasma display panel (PDP) and a plasma display device. More specifically, the present invention relates to an address driving circuit for applying address voltages.

(b) Description of the Related Art

The PDP is a flat display that uses plasma generated via a gas discharge process to display characters or images, and, depending on its size, tens to millions of pixels are provided thereon in a matrix format PDPs are categorized as DC PDPs and AC PDPs, according to the supplied driving voltage waveforms and discharge cell structures.

DC PDPs have electrodes exposed in the discharge space, and they allow a current to flow in the discharge space while the voltage is supplied. Therefore they problematically require resistors for current restriction. AC PDPs, on the other hand, have electrodes covered by a dielectric layer, and capacitances are naturally formed to restrict the current. Furthermore, in AC PDPs the electrodes are protected from ion shocks during discharge. As a result, AC PDPs have a longer lifespan than DC PDPs.

FIG. 1 shows a perspective view of an AC PDP.

As shown, a scan electrode 4 and a sustain electrode 5, disposed over a dielectric layer 2 and a protection film 3, are provided in parallel and form a pair with each other under a first glass substrate 1. A plurality of address electrodes 8 covered with an insulation layer 7 are installed on a second glass substrate 6. Barrier ribs 9 are formed in parallel with the address electrodes 8 on the insulation layer 7 between the address electrodes 8, and phosphor 10 is formed on the surface of the insulation layer 7 between the barrier ribs 9. The first and second glass substrates 1 and 6 having a discharge space 11 between them are provided facing each other so that the scan electrode 4 and the sustain electrode 5 may respectively cross the address electrode 8. The address electrode 8 and discharge space 11 formed at a crossing part of the scan electrode 4 and the sustain electrode 5 form a discharge cell 12.

FIG. 2 shows a PDP electrode arrangement diagram.

As shown, the PDP electrode has an m×n matrix configuration, and in detail, it has address electrodes A₁ to Aₘ in the column direction, and scan electrodes Y₁ to Yₙ and sustain electrodes X₁ to Xₙ in the row direction, alternately. The discharge cell 12 shown in FIG. 2 corresponds to the discharge cell 12 shown in FIG. 1.

In general, a method for driving the AC PDP includes a reset period, an address period, and a sustain period.

In the reset period, the states of the respective cells are reset to address the cells smoothly. In the addressing period, the cells to be turned on and the cells not to be turned on in a panel are selected, and wall charges are accumulated in the cells to be turned on (i.e., the addressed cells). In the sustain period, discharge is performed to turn on the addressed cells and actually display pictures.

Because a discharge space between a scan electrode and a sustain electrode, as well as a discharge space between a surface on which an address electrode is formed and a surface on which scan and sustain electrodes are formed, each operates as a capacitive load (referred to as panel capacitors hereinafter), capacitance exists on the panel. Hence, in addition to power for addressing, reactive power is also needed to apply waveforms for addressing. An address driving circuit of the PDP therefore includes a power recovery circuit for recovering the reactive power and re-using the same, as disclosed from the power recovery circuit by L. F. Weber in U.S. Pat. Nos. 4,866,349 and 5,081,400.

A conventional power recovery circuit can restrict power consumption within a predetermined level when images that need high power consumption are displayed. However, the conventional power recovery circuit is also operated when images that need low power consumption are displayed. As a result, the power consumption of the conventional power recovery circuit is higher than the power consumption of a circuit that does not recover power when images that need only low power consumption are displayed. For example, in the display pattern in which all discharge cells are on, the addressing voltage is continuously applied to the address electrodes. Therefore, the power recovery operation need not be performed in this display pattern. However, power consumption is higher than necessary because the conventional power recovery circuit performs power recovery in this display pattern.

The conventional power recovery circuits fail to recover 100% of the reactive power during the power recovery process because of switching losses of the transistors or parasitic components of the circuit. Accordingly, the power recovery operation cannot adjust the voltage of the panel capacitor to a desired voltage. Hence, the switch performs hard switching.

### SUMMARY OF THE INVENTION

The present invention provides an address driving circuit for reducing power consumption.

The present invention provides an address driving circuit for varying a power recovery operation according to the switching variation of an address selecting circuit.

In one aspect of the present invention, a plasma display device comprises: a panel including a plurality of first electrodes extending in a first direction and a plurality of second electrodes extending in a second direction intersecting the first direction; a first driving circuit sequentially applying a first voltage to the first electrodes; a selecting circuit coupled to the second electrodes for selecting second electrodes to which a second voltage will be applied from among the second electrodes; a second driving circuit including at least one inductor having a first terminal coupled to the selecting circuit and a capacitor coupled to a second terminal of the inductor for applying the second voltage to the second electrode selected by the selecting circuit; and a controller selecting an operating mode of the second driving circuit in response to a video signal. When the operating mode is a first mode, the second driving circuit applies the second voltage to the selected second electrode after charging a capacitive load formed by the first electrode and the selected second electrode through the capacitor and the inductor, and discharges the capacitive load through the capacitor and the inductor, thereby reducing the voltage of the selected second electrode, and a residual voltage after the capacitive load is discharged is reduced by an operation of the selecting circuit. When the operating mode is a second mode, the second driving circuit directly applies the second voltage to the selected second electrode.

In one exemplary embodiment, the controller selects the operating mode to be the first mode when the number of first discharge cells is more than a predetermined value in at least one subfield. The on/off state of the first discharge cell is different from that of the discharge cell adjacent to the first discharge cell in the first direction.

In another exemplary embodiment, the controller selects the operating mode to be the first mode when a summation of the number of first discharge cells and the number of second discharge cells is more than a predetermined value in at least one subfield. The on/off state of the first discharge cell is different from that of the adjacent discharge cell in the first direction, and the on/off state of the second discharge cell is different from that of the adjacent discharge cell in the second direction.

In still another exemplary embodiment, the second driving circuit supplies a current to the capacitor before discharging the capacitive load in the first mode. The current supplied to the capacitor may be supplied from the voltage source supplying the second voltage.

In a further exemplary embodiment, in the first mode, the second driving circuit operates in the following order: a first period during which the capacitive load is charged through the inductor and the voltage charged in the capacitor; a second period during which the selected second electrode of the capacitive load is substantially maintained at the second voltage through the voltage source supplying the second voltage; a third period during which a current is supplied to the inductor and the capacitor by using the voltage source; and a fourth period during which the capacitive load is discharged by using the voltage charged in the capacitor and the inductor.

In yet a further exemplary embodiment, the second driving circuit further includes a first switch and a second switch coupled between the second terminal of the inductor and the capacitor or between the first terminal of the inductor and the selecting circuit in parallel; and a third switch coupled between a voltage source supplying the second voltage and the selecting circuit. The first switch, the second switch and the third switch may be transistors respectively including a body diode, and the second driving circuit may further include a first diode formed in the opposite direction of the body diode of the first switch in the path formed by the capacitor, the first switch, and the inductor; and a second diode formed in the opposite direction of the body diode of the second switch in the path formed by the capacitor, the second switch, and the inductor.

In a still further exemplary embodiment, in the first mode, the second driving circuit operates in the following order: a first period during which the first switch is turned on, a second period during which the third switch is turned on, a third period during which the second switch and the third switch are turned on, and a fourth period during which the second switch is turned on. In addition, in the second mode, the first switch is turned on, and the second switch and the third switch are turned off.

Yet another exemplary embodiment includes a first inductor and a second inductor, and the second driving circuit charges the capacitive load through the first inductor and discharges the capacitive load through the second inductor.

In still another exemplary embodiment, the inductor on the path of charging the capacitive load is the same as the inductor on the path of discharging the capacitive load.

In a further exemplary embodiment, the selecting circuit includes a plurality of first switches respectively coupled between the second electrodes and the first terminal of the inductor, and a plurality of second switches respectively coupled between the second electrodes and a voltage source for supplying a third voltage. The discharge cells to be turned on may be selected by the second electrode coupled to the turned-on first switch and the first electrode to which the first voltage is applied. The second driving circuit may operate in the second mode when the first switches of the selecting circuit are continuously turned on while the first voltage is sequentially applied to the first electrodes.

In another aspect of the present invention, a driving method of a PDP on which a plurality of first electrodes and second electrodes are formed is provided, and a capacitive load is formed by the first and second electrodes. The driving method includes: selecting operating modes in the respective subfields from a video signal; selecting the first electrodes to which a first voltage will be applied among the first electrodes; and applying a second voltage to the first electrodes that are not selected. When the operating mode is a first mode, the driving method further includes: increasing a voltage of the selected first electrode through a first inductor having a first terminal coupled to the first electrode; substantially maintaining a voltage of the selected first electrode at the first voltage through a first voltage source supplying the first voltage; supplying a current to a second inductor having a first terminal coupled to the first electrode while substantially maintaining a voltage of the selected first electrode at the first voltage; and reducing the voltage of the selected first electrode through the second inductor. When the operating mode is a second mode, the driving method further includes applying the first voltage to the first electrode selected through the first voltage source.

In one exemplary embodiment, in the first mode, a capacitor is coupled to a second terminal of the first inductor and a second terminal of the second inductor when the voltage of the first electrode is increased and reduced.

In another exemplary embodiment, the first and second inductors are the same.

In still another exemplary embodiment, the first and second inductors are different.

In a further exemplary embodiment, a third voltage is sequentially applied to the second electrodes. In addition, in the first mode, increasing a voltage of the first electrode selected through a first inductor having a first terminal coupled to the first electrode, substantially maintaining a voltage of the selected first electrode at the first voltage through a first voltage source supplying the first voltage, supplying a current to a second inductor coupled to the first electrode while substantially maintaining a voltage of the selected first electrode at the first voltage, and reducing the voltage of the selected first electrode through the second inductor are repeated each time the third voltage is applied to the second electrode. Furthermore, the voltage of the capacitor is varied according to a combination of a previously selected first electrode and a currently selected first electrode.

In still another aspect of the present invention, a plasma display device includes: a panel including a plurality of first electrodes extending in a first direction and a plurality of second electrodes extending in a second direction intersecting the first direction; a first driving circuit sequentially applying a first voltage to the first electrodes; a selecting circuit coupled to the second electrodes for selecting second electrodes to which data will be applied among the second electrodes; and a second driving circuit including at least one inductor coupled to the selecting circuit and a capacitor coupled to the inductor. The second driving circuit electrically intercepts between the inductor and the capacitor and applies a second voltage to the second electrodes selected by the selecting circuit when a total summation in a predetermined number of discharge cells of the data difference between two discharge cells adjacent in the second direction is less than a predetermined value. The second driving circuit charges and discharges a capacitive load formed by the second electrode selected by the selecting circuit and the first electrode by using the inductor and the capacitor, and applies the second voltage to the second electrode selected after charging the capacitive load when the total summation is more than the predetermined value.

In a further aspect of the present invention, a plasma display device comprises: a panel including a plurality of scan electrodes extending in a first direction and a plurality of address electrodes extending in a second direction intersecting the first direction; a first driving circuit sequentially applying a first voltage to the scan electrodes; a selecting circuit coupled to the address electrodes for selecting address electrodes to which data will be applied among the address electrodes; a second driving circuit coupled to the address electrodes selected through the selecting circuit; and a controller selecting an operating mode of the second driving circuit in response to a video signal. The second driving circuit comprises: at least one inductor having a first terminal coupled to the address electrodes; a first switch coupled between a voltage source supplying an address voltage and the address electrodes; a capacitor coupled to a second terminal of the inductor; and at least one second switch coupled between the second terminal of the inductor and the capacitor or between the inductor and the selecting circuit. When the operating mode is the first mode, the second driving circuit increases and reduces a voltage of the address electrode by on/off operation of the second switch, and a residual voltage after the voltage of the address electrode is reduced to a predetermined voltage by an operation of the selecting circuit. When the operating mode is the second mode, the second driving circuit electrically intercepts between the capacitor and the inductor by turning off the second switch.

In yet a further aspect of the present invention, a plasma display device comprises: a panel including a plurality of first electrodes extending in a first direction and a plurality of second electrodes extending in a second direction intersecting the first direction; a first driving circuit sequentially applying a first voltage to the first electrodes; a selecting circuit coupled to the second electrodes for selecting second electrodes to which data will be applied among the second electrodes; and a second driving circuit including at least one inductor coupled to the selecting circuit and a capacitor coupled to the inductor. The inductor and the capacitor are electrically intercepted in a first operating mode, and the voltage of the capacitor is variable according to the display pattern in a second operating mode.

In a still further aspect of the present invention, a plasma display device comprises: a panel including a plurality of first electrodes extending in a first direction and a plurality of second electrodes extending in a second direction intersecting the first direction; a first driving circuit sequentially applying a first voltage to the first electrodes; a selecting circuit coupled to the second electrodes for selecting second electrodes to which data will be applied among the second electrodes; and a second driving circuit including at least one inductor coupled to the selecting circuit and a capacitor coupled to the inductor. In a first operating mode, resonance between the inductor and the capacitor is not generated. In a second mode, resonance between the inductor and the capacitor is generated, and the voltage of the capacitor is variable according to the display pattern.

### BRIEF DESCRIPTION OF THE DRAWINGS

FIG. 1 shows a partial perspective view of an AC PDP.

FIG. 2 shows a PDP electrode arrangement diagram.

FIG. 3 shows a diagram of a plasma display device according to an exemplary embodiment of the present invention.

FIG. 4 shows an address driving circuit according to a first exemplary embodiment of the present invention.

FIG. 5 shows a reduced diagram of the address driving circuit of FIG. 4.

FIG. 6 shows a diagram of a dot on/off pattern.

FIG. 7 shows a diagram of a line on/off pattern.

FIG. 8 shows a diagram of a full white pattern.

FIG. 9 shows a timing diagram of a power recovery circuit of FIG. 5 for showing the dot on/off pattern.

FIGS. 10A to 10H show current paths for respective modes of the address driving circuit of FIG. 5 following the timing of FIG. 9.

FIG. 11 shows a timing diagram of the power recovery circuit of FIG. 5 for showing the full white pattern.

FIGS. 12A to 12D show current paths for respective modes of the address driving circuit of FIG. 5 following the timing of FIG. 11.

FIG. 13 shows an address driving circuit according to a second exemplary embodiment of the present invention.

FIG. 14 shows the power consumption in the address driving circuit according to the first exemplary embodiment of the present invention.

FIG. 15 shows a controller of a plasma display device according to a third exemplary embodiment of the present invention.

FIG. 16 shows the power consumption of the driving circuit according to the third exemplary embodiment of the present invention.

### DETAILED DESCRIPTION

In the following detailed description, only an exemplary embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

A plasma display device and a driving method of a PDP will be described in detail with reference to drawings.

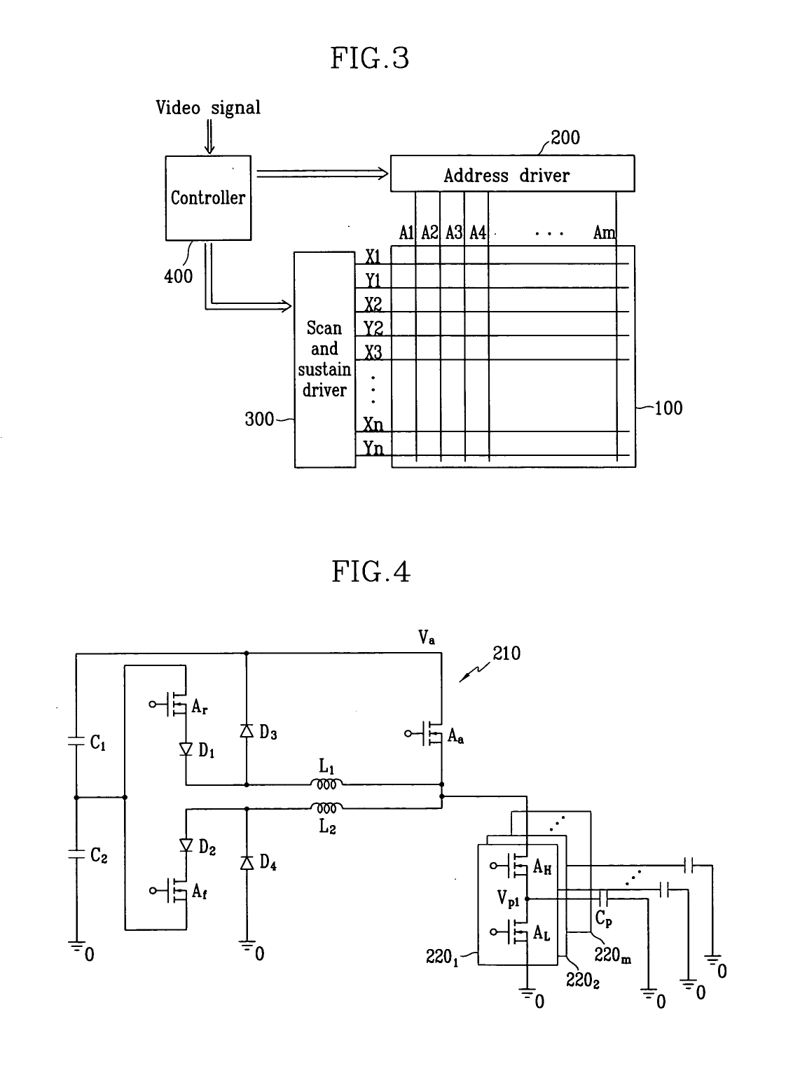

FIG. 3 shows a brief diagram of a plasma display device according to an exemplary embodiment of the present invention.

As shown in FIG. 3, the plasma display device includes a PDP 100, an address driver 200, a scan and sustain driver 300, and a controller 400. The scan and sustain driver 300 is illustrated as a single block in FIG. 3, but generally can be separated into a scan driver and a sustain driver.

The PDP 100 includes a plurality of address electrodes A₁ to Aₘ extending in the column direction, and a plurality of scan electrodes Y₁ to Yₙ and a plurality of sustain electrodes is X₁ to Xₙ extending in pairs in the row direction. The address driver 200 receives an address drive control signal from the controller 400, and applies address signals to the respective address electrodes A₁ to Aₘ for selecting discharge cells to be displayed. The scan and sustain driver 300 receives a sustain control signal from the controller 400, and alternately inputs sustain pulses to the scan electrodes Y₁ to Yₙ and sustain electrodes X₁ to Xₙ to sustain the selected discharge cells. The controller 400 receives external video signals, generates an address drive control signal and a sustain control signal, and applies them to the address driver 200 and the scan and sustain driver 300.

In general, a single frame is divided into a plurality of subfields, the subfields are driven in the PDP, and the discharge cells to be discharged are selected from among the discharge cells. In order to select the discharge cells, a scan voltage is sequentially applied to the scan electrodes, and the scan electrodes to which no scan voltage is applied are biased with a positive voltage during the address period. The voltage for addressing (referred to as an address voltage hereinafter) is applied to the address electrodes that are passed through the discharge cells to be selected from among a plurality of discharge cells formed by the scan electrodes to which the scan voltage is applied, and a reference voltage is applied to the address electrodes that are not selected. In general, the address voltage uses a positive voltage and the scan voltage uses a ground voltage or a negative voltage so that the discharge is generated at the address electrodes to which the address voltage is applied and the scan electrodes to which the scan voltage is applied, and the corresponding discharge cells are selected. The ground voltage is frequently used as the reference voltage.

An address driving circuit in the address driver 200 will be described with reference to FIG. 4 with the assumption that the scan voltage is applied to the scan electrodes and the reference voltage is applied to the address electrodes as the ground voltage.

FIG. 4 shows an address driving circuit according to a first exemplary embodiment of the present invention.

As shown in FIG. 4, the address driving circuit includes a power recovery circuit 210 and a plurality of address selecting circuits 220₁ to 220ₘ. The address selecting circuits 220₁ to 220ₘ are respectively connected to a plurality of address electrodes A₁ to Aₘ, and each address selecting circuit has two switches A_{H} and A_{L} as a driving switch and a grounding switch, respectively. The switches A_{H} and A_{L} may be composed of a field-effect transistor (FET) having a body diode, or other types of switches that perform the same or similar functions as the FET. In FIG. 4, each of the switches A_{H} and A_{L} comprises an N-channel MOSFET. A first terminal (drain) of switch A_{H} is connected to the power recovery circuit 210 and a second terminal (source) of switch A_{H} is connected to the address electrodes A₁ to Aₘ, and when switch A_{H} is turned on, an address voltage Vₐ supplied by the power recovery circuit 210 is transmitted to the address electrodes A₁ to Aₘ. Switch A_{L} has a first terminal (drain) connected to the address electrodes A₁ to Aₘ and a second terminal (source) connected to the reference voltage (ground voltage), and when switch A_{L} is turned on, the ground voltage is transmitted to the address electrodes A₁ to Aₘ. In addition, switches A_{H} and A_{L} are not simultaneously turned on.

The address voltage Vₐ or the ground voltage is applied to the address electrodes A₁ to Aₘ when switches A_{H} and A_{L} of the address selecting circuits 220₁ to 220ₘ respectively connected to the address electrodes A₁ to Aₘ are turned on or off by a control signal as described above. In the address period, the address electrode to which the address voltage Vₐ is applied when switch A_{H} is turned on is selected, and the address electrode to which the ground voltage is applied when switch A_{L} is turned on is not selected.

The power recovery circuit 210 includes switches Aₐ, Aᵣ, and A_{f}, inductors L₁ and L₂, diodes D₁ and D₂, and capacitors C₁ and C₂. Switches Aₐ, Aᵣ, and A_{f} respectfully may be composed of an FET having a body diode or other types of switches that perform the same or similar functions as the FET. In FIG. 4, each of the switches Aₐ, Aᵣ, and A_{f} is composed of an N-channel MOSFET. A first terminal (drain) of switch Aₐ is connected to a voltage source for supplying the address voltage Vₐ and a second terminal (source) of switch Aₐ is connected to the first terminal of switch A_{H} of the address selecting circuits 220₁ to 220ₘ. Capacitors C₁ and C₂ are connected in series between the voltage source for supplying the address voltage Vₐ and the ground voltage. The first terminal of switch A_{H} of the address selecting circuits 220₁ to 220ₘ is connected to the first terminals of the inductors L₁ and L₂. Switch Aᵣ and diode D₁ are connected in series between a common node of capacitors C₁ and C₂ and the second terminal of inductor L₁. Diode D₂ and switch Aᵣ are connected in series between the second terminal of inductor L₂ and the common node of capacitors C₁ and C₂.

The connection sequence of inductor L₁, diode D₁, and switch Aᵣ can be changed, and the connection sequence of inductor L₂, diode D₂, and switch A_{f} can be changed. Diodes D₁ and D₂ prevent current paths that may be caused by a body diode at the respective switches Aᵣ and A_{f}, and diodes D₁ and D₂ can be eliminated if no body diode exists. A clamping diode D₃ can be connected between the second terminal of inductor L₁ and the voltage source for supplying the address voltage Vₐ so that the voltage applied to the address electrodes A₁ to Aₘ may not exceed the address voltage Vₐ during operation of the power recovery circuit 210. In the same manner, a clamping diode D₄ can be connected between the ground voltage and the second terminal of inductor L₂ so that the voltage applied to the address electrodes A₁ to Aₘ may not be less than the ground voltage.

A single power recovery circuit 210 is illustrated as connected to the address selecting circuits 220₁ to 220ₘ in FIG. 4. In addition, the address selecting circuits 220₁ to 220ₘ can be divided into a plurality of groups with a power recovery circuit 210 connected to each group. Capacitors C₁ and C₂ are connected in series between the voltage source for supplying the address voltage Vₐ and the ground voltage in FIG. 4, and capacitor C₁ can further be eliminated.

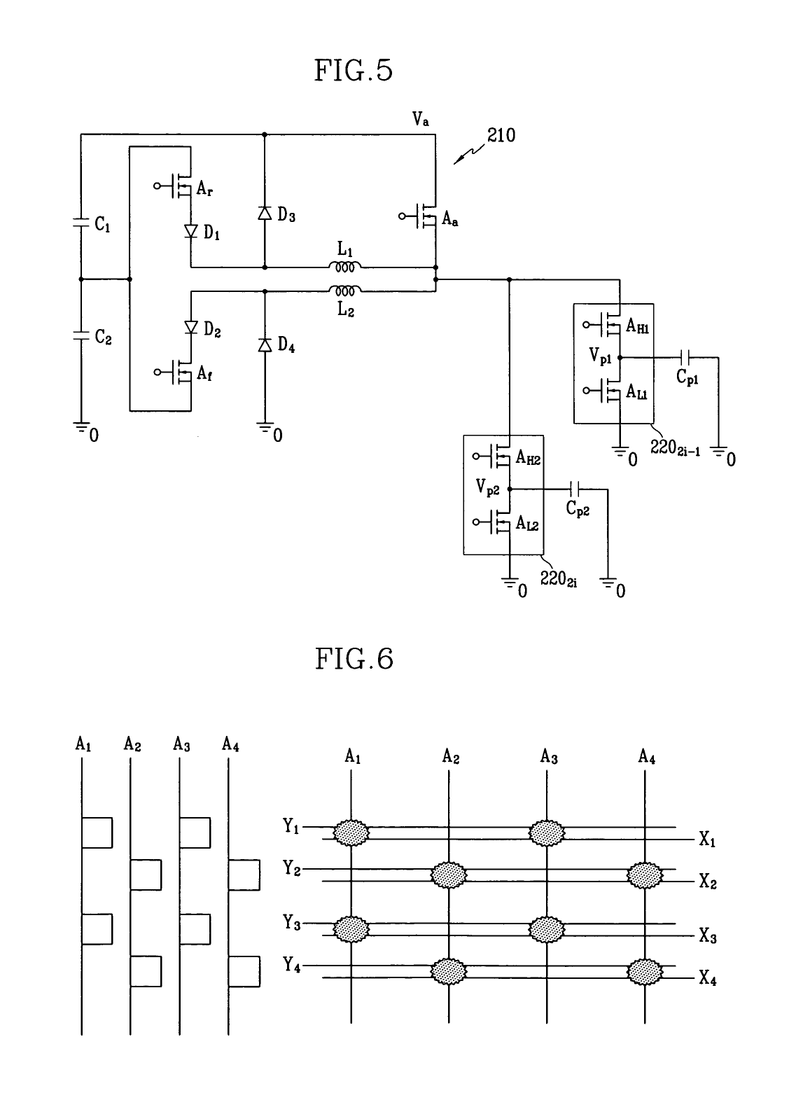

Referring to FIGS. 5 through 12D, an operation of the address driving circuit according to the first exemplary embodiment of the present invention will be described. The threshold voltage of semiconductor elements (switch or diode) is assumed to be at 0V as the threshold voltage is very much lower than the discharging voltage.

FIG. 5 shows a brief diagram of the address driving circuit of FIG. 4. For ease of description, only two adjacent address selecting circuits 220₂ᵢ₋₁ and 220₂ᵢ are illustrated. A capacitive component formed by the address electrode and the scan electrode is illustrated as a panel capacitor, and the ground voltage is applied to the scan electrode part of the panel capacitor.

As shown in FIG. 5, the power recovery circuit 210 is connected to panel capacitors Cₚ₁ and Cₚ₂ through switches A_{H1} and A_{H2} of the address selecting circuits 220₂ᵢ₋₁ and 220₂ᵢ, and switches A_{L1} and A_{L2} of the address selecting circuits 220₂ᵢ₋₁ and 220₂ᵢ are connected to the ground voltage. The panel capacitor Cₚ₁ is a capacitive component formed by the address electrode A₂ᵢ₋₁ and the scan electrode, and the panel capacitor Cₚ₂ is a capacitive component formed by the address electrode A₂ᵢ and the scan electrode.

An operation of the address driving circuit will be described by using representative patterns of FIGS. 6 through 8 displayed on a screen in a single subfield. The representative patterns include the dot on/off pattern and the line on/off pattern having many switching variations of the address selecting circuits 220₁ to 220ₘ, and the full white pattern having less switching variations of the address selecting circuits 220₁ to 220ₘ.

FIGS. 6 through 8 respectively show concept diagrams of the dot on/off pattern, the line on/off pattern, and the full white pattern.

These patterns are determined by a switching operation of the address selecting circuits 220₁ to 220ₘ; the timing of switches A, Aᵣ, and A_{f} of the power recovery circuit 210 is the same in any case of realizing the patterns. Switching variation of the address selecting circuit results when turn-on and turn-off operations of the switches A_{H} and A_{L} of the address selecting circuit are repeated as the scan electrodes are sequentially selected.

Referring to FIG. 6, the dot on/off pattern is a display pattern generated when the address voltage is alternately applied to the odd and even address electrodes as the scan electrodes are sequentially selected. For example, the address voltage is applied to the odd address electrodes A₁ and A₃ to select odd columns of the first row when the first scan electrode Y₁ is selected, and the address voltage is applied to the even address electrodes A₂ and A₄ to select emission in the even columns of the second row when the second scan electrode Y₂ is selected. To accomplish this addressing, switch A_{H} of the odd address selecting circuit is turned on and switch A_{L} of the even address selecting circuit is turned on when the scan electrode Y₁ is selected, whereas switch A_{H} of the even address selecting circuit is turned on and switch A_{L} of the odd address selecting circuit is turned on when the scan electrode Y₂ is selected.

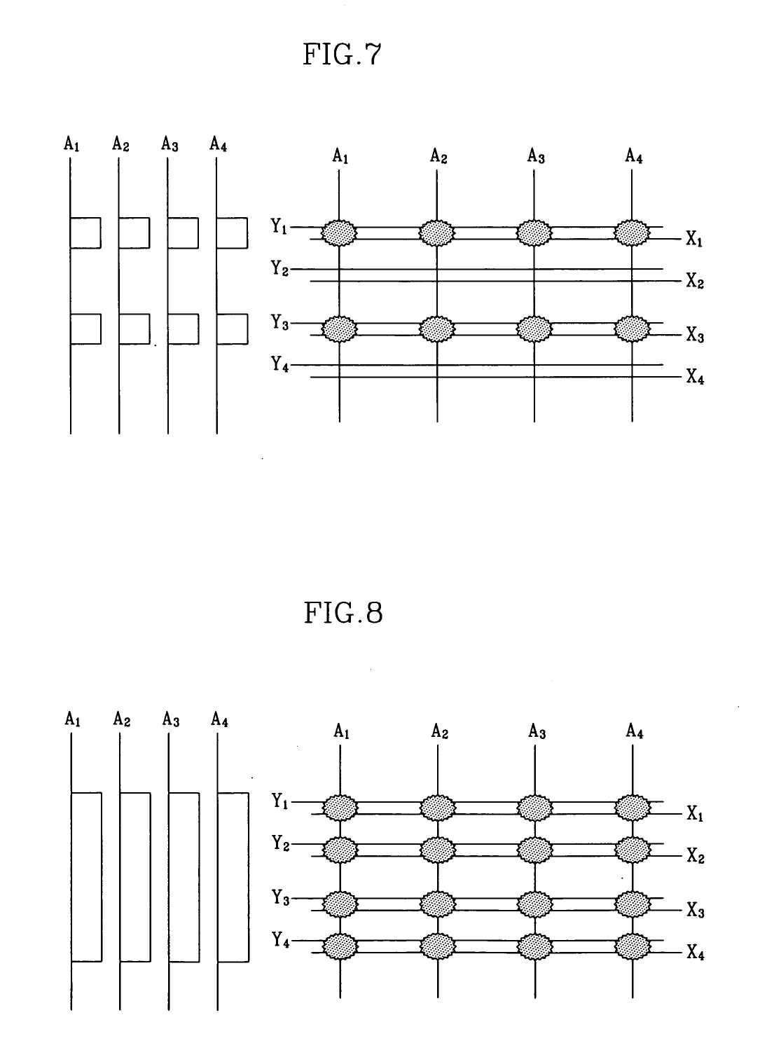

Referring to FIG. 7, the line on/off pattern is a pattern in which the address voltage is applied to all the address electrodes A₁ to A₄ when the first scan electrode Y₁ is selected, and ground voltage is applied to the address electrodes A₁ to A₄ when the second scan electrode Y₂ is selected. To accomplish this addressing, switches A_{H} of all the address selecting circuits are turned on when the scan electrode Y₁ is selected, and switches A_{L} of all the address selecting circuits are turned on when the scan electrode Y₂ is selected.

Referring to FIG. 8, the full white pattern is a display pattern generated when the address voltage is continuously applied to all the address electrodes as the scan electrodes are sequentially selected. That is, switches A_{H} of all the address selecting circuits are always turned on.

Switches A_{L} of the address selecting circuits are periodically turned on in the dot on/off pattern and the line on/off pattern, but are not turned on in the full white pattern. Turn-on states of the switch A_{L} determine the voltage at capacitor C₂ in the power recovery circuit of FIG. 5.

An operation of the address driving circuit of FIG. 5 will be described in detail by exemplifying the dot on/off pattern and the full white pattern since the dot on/off pattern and the line on/off pattern perform similar functions regarding switches A_{L} being periodically turned on.

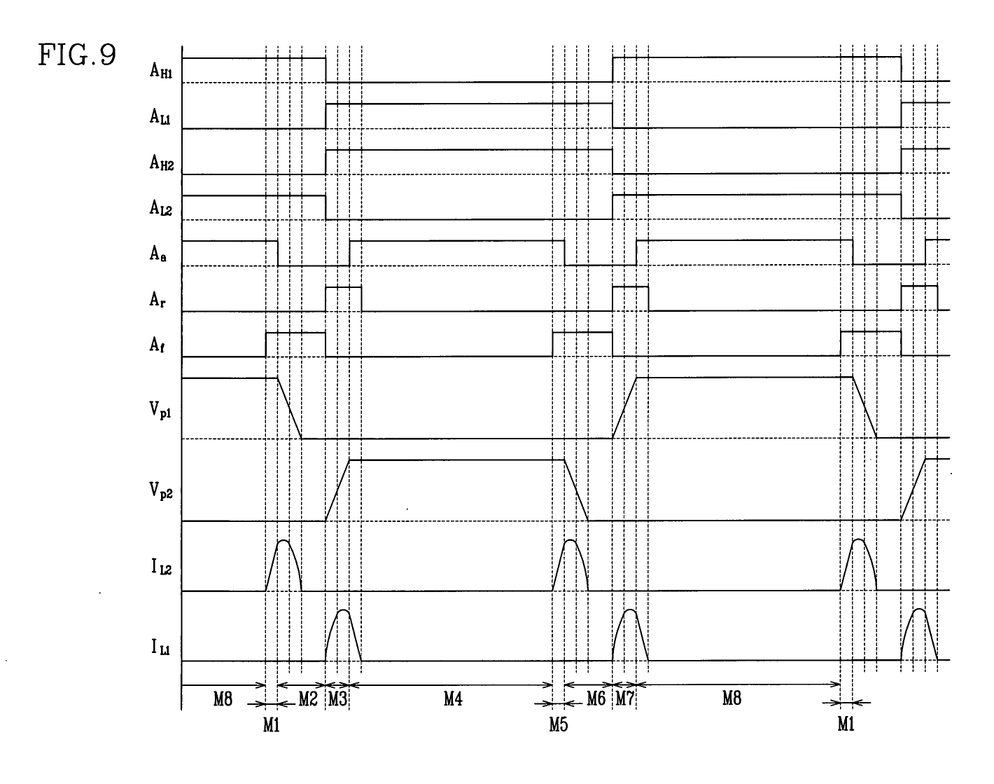

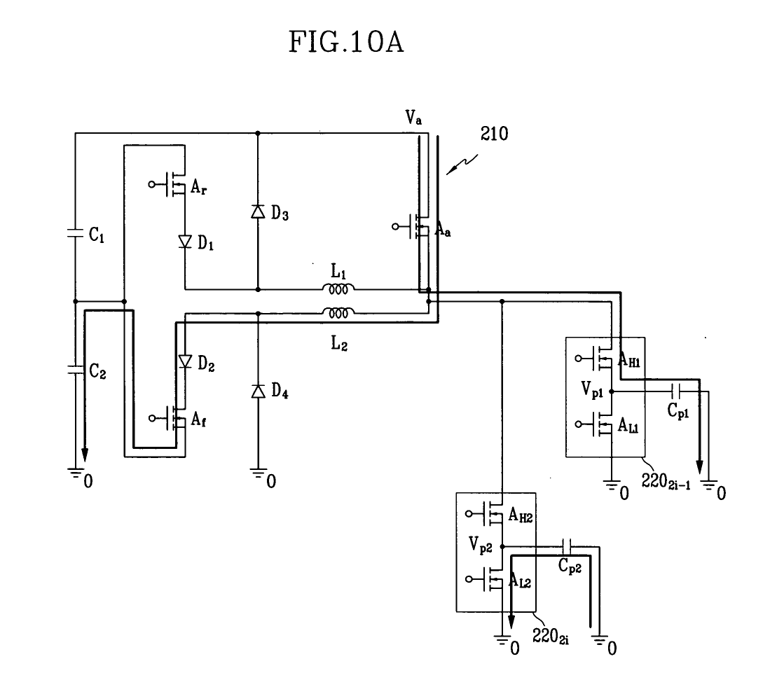

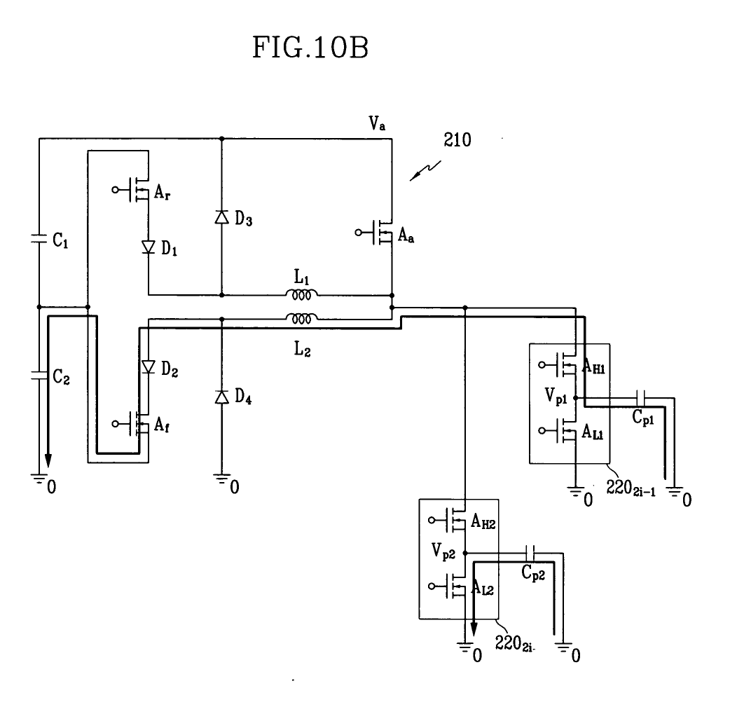

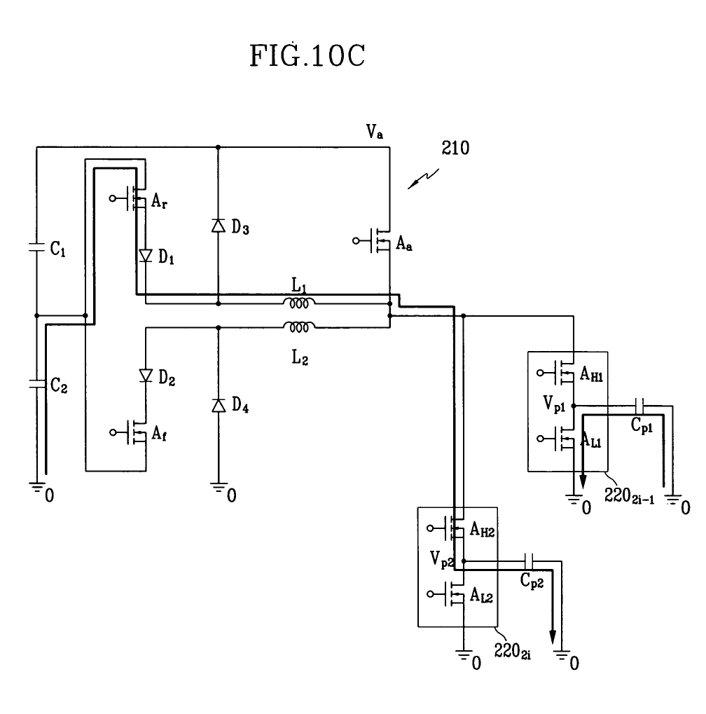

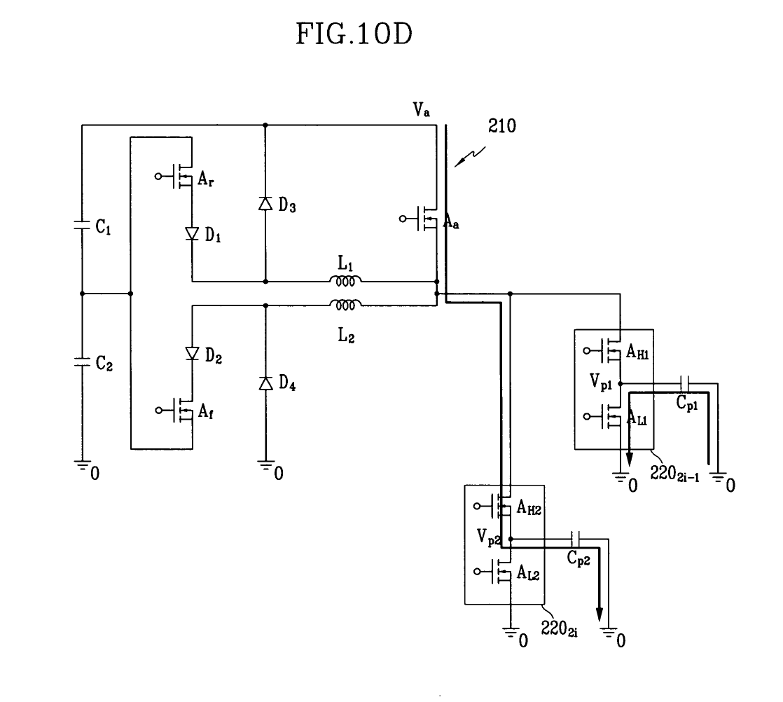

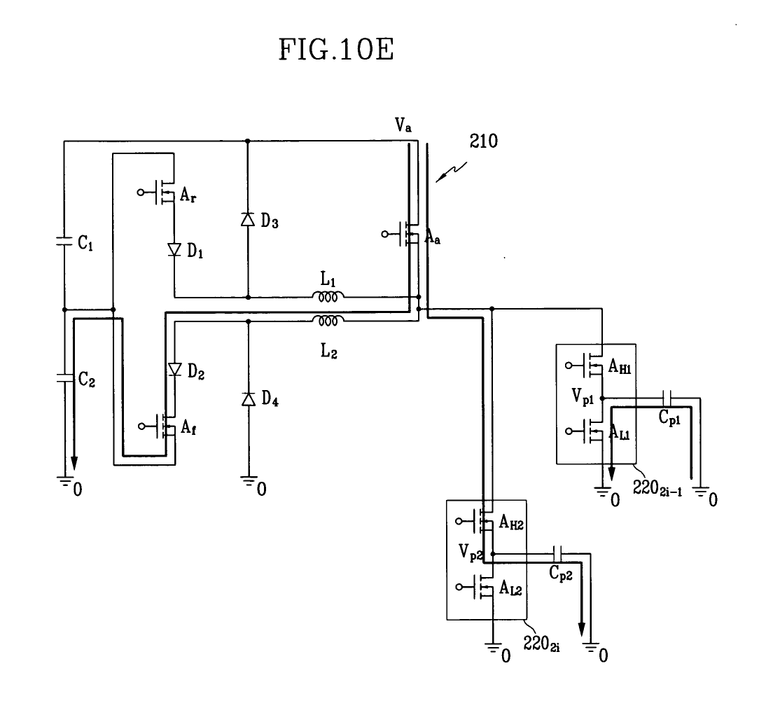

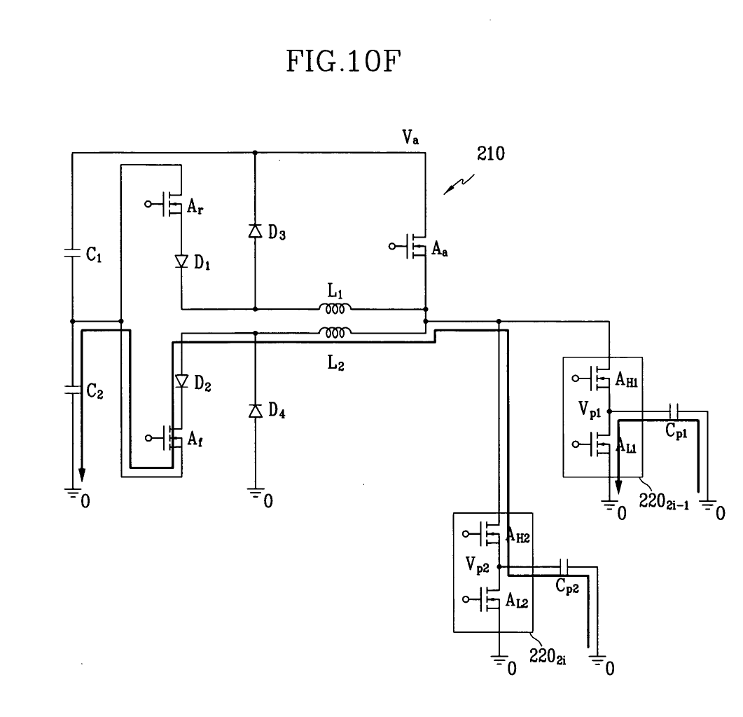

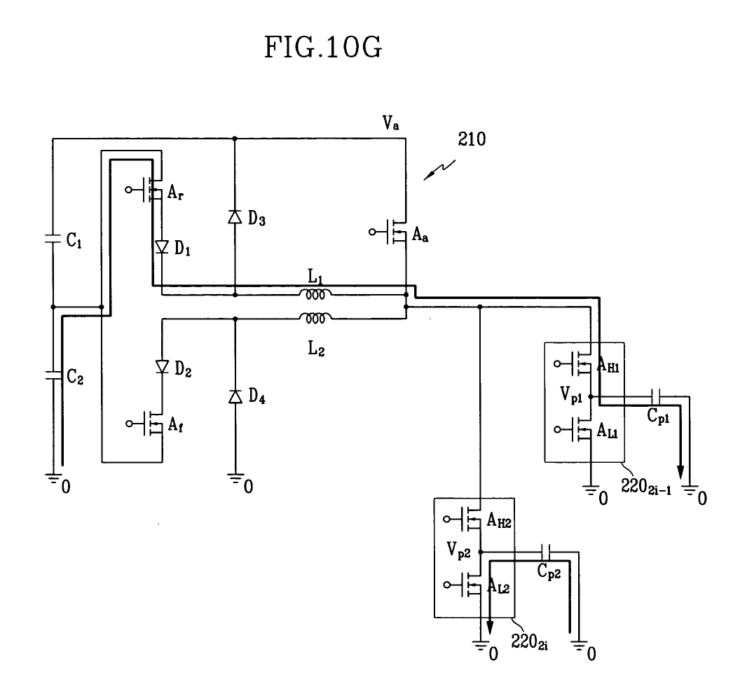

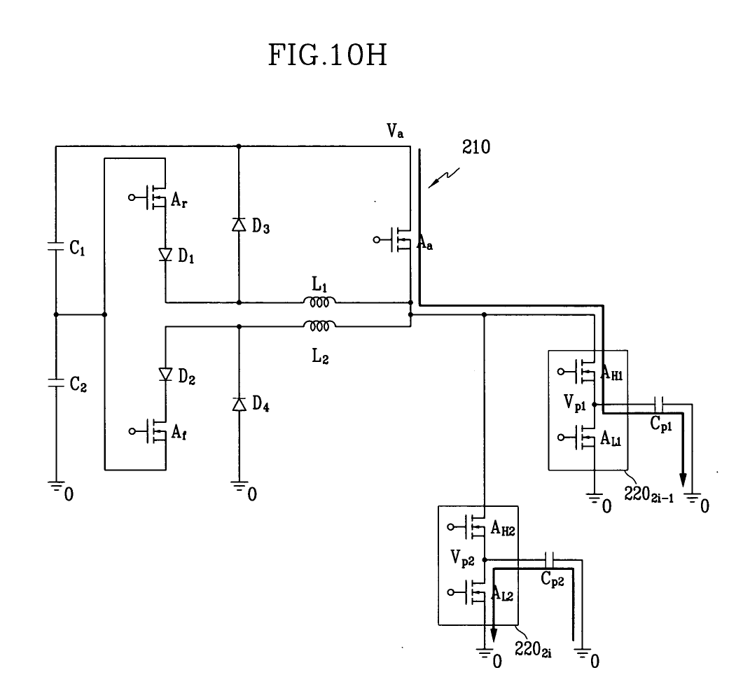

1. Dot on/off pattern (Refer to FIGS. 9, and 10A to 10H)

First, the temporal operation of the address driving circuit for displaying a pattern with many switching variations of the address selecting circuits 220₁ to 220ₘ in the case of the dot on/off pattern will be described with reference to FIGS. 9 and 10A to 10H. The operation variation has eight sequential modes, and the modes are varied by a manipulation of the switches. A resonance phenomenon arises, but it is not a continuous oscillation. Instead it is a voltage and current variation caused by combination of an inductor L₁ or L₂ and a panel capacitor Cₚ₁ or Cₚ₂ when the switches Aᵣ and A_{f} are turned on.

FIG. 9 shows a timing diagram of a power recovery circuit of FIG. 5 for showing the dot on/off pattern, and FIGS. 10A to 10H show current paths for respective modes of the address driving circuit of FIG. 5 following the timing of FIG. 9.

In the case that the dot on/off pattern is displayed in the circuit of FIG. 5, switch A_{H1} of the address selecting circuit 220₂ᵢ₋₁ connected to the odd address electrode A₂ᵢ₋₁ and switch A_{L2} of the address selecting circuit 220₂ᵢ connected to the even address electrode A₂ᵢ are turned on, and switch A_{H2} of the address selecting circuit 220₂ᵢ and switch A_{L1} of the address selecting circuit 220₂ᵢ₋₁ are turned off when a single scan electrode is selected. Switches A_{H1} and A_{L2} are turned off and switches A_{H2} and A_{L1} are turned on when the next scan electrode is selected. These operations are repeated. When the dot on/off pattern is displayed as described above, switches A_{H1} and A_{H2} and switches A_{L1} and A_{L2} of the address selecting circuits 220₂ᵢ₋₁ and 220₂ᵢ are continuously turned on and off by synchronizing with the scan voltage sequentially applied to the scan electrodes.

It is assumed in FIG. 9 that switches A_{H1}, A_{L2}, and Aₐ are turned on and switches A_{H2} and A_{L1} are turned off before mode 1 starts so that the voltage Vₐ is applied to panel capacitor Cₚ₁ and the voltage 0V is applied to panel capacitor Cₚ₂. Thus, it is assumed that the voltage Vₐ is applied to the odd address electrode A₂ᵢ₋₁ and the voltage 0V is applied to the even address electrode A₂ᵢ.

In mode 1, switch A_{f} is turned on while switches A_{H1}, A_{L2}, and Aₐ are turned on and switches A_{H2} and A_{L1} are turned off. Then, as shown in FIG. 10A, current is injected into inductor L₂ and capacitor C₂ through the path of the voltage source Vₐ, switch Aₐ, inductor L₂, diode D₂, switch A_{f}, and capacitor C₂, and capacitor C₂ is charged with a voltage.

In mode 2, switch Aₐ is turned off to form a resonance path through panel capacitor Cₚ₁, the body diode of switch A_{H1}, inductor L₂, diode D₂, switch A_{f}, and capacitor C₂ as shown in FIG. 10B. Voltage Vₚ₁ of panel capacitor Cₚ₁ is reduced by the resonance path, and voltage Vₚ₂ of panel capacitor Cₚ₂ is maintained at 0V because switch A_{L2} is turned on. The current (energy) discharged from panel capacitor Cₚ₁ is supplied to capacitor C₂, and capacitor C₂ is charged with a voltage.

In mode 3, switches A_{H1} and A_{L2} are turned off and switches A_{H2} and A_{L1} are turned on to apply the voltage 0V to panel capacitor Cₚ₁. Switch A_{f} is turned off and switch Aᵣ is turned on to form a resonance path through capacitor C₂, switch Aᵣ, diode D₁, inductor L₁, switch A_{H2}, and panel capacitor Cₚ₂ as shown in FIG. 10C. The current is supplied from capacitor C₂ by the resonance path to increase the voltage Vₚ₂ of panel capacitor Cₚ₂ and discharge capacitor C₂. In this instance, voltage Vₚ₂ of panel capacitor Cₚ₂ does not exceed voltage Vₐ because the body diode of switch Aₐ is turned on when voltage Vₚ₂ of panel capacitor Cₚ₂ exceeds voltage Vₐ. The current remaining in inductor L₁ when the voltage of panel capacitor Cₚ₂ reaches Vₐ is recovered to the voltage source Vₐ through the body diode of switch Aa.

In mode 4, switch Aₐ is turned on and switch Aᵣ is turned off to maintain voltage Vₚ₂ of panel capacitor Cₚ₂ at Vₐ as shown in FIG. 10D.

As described above, the power recovery circuit 210 supplies the voltage Vₐ to the address electrode A₂ᵢ through switch A_{H2} of the address selecting circuit 220₂ᵢ during modes 1 to 4. The address electrode A₂ᵢ₋₁ is maintained at 0V through switch A_{L1} of the address selecting circuit 220₂ᵢ₋₁.

In modes 5 to 8, the operation of the switches of the power recovery circuit is the same as that described above except for the operation of the switches of the address selecting circuit.

In mode 5, switch A_{f} is turned on while switches A_{H2}, A_{L1}, and Aₐ are turned on and switches A_{H1} and A_{L2} are turned off. Hence, current is injected into inductor L₂ and capacitor C₂ through the path of the voltage source Vₐ, switch Aₐ, inductor L₂, diode D₂, switch A_{f} and capacitor C₂ as shown in FIG. 10E, and capacitor C₂ is charged with a voltage.

In mode 6, switch Aₐ is turned off to form a resonance path through panel capacitor Cₚ₂, the body diode of switch A_{H2}, inductor L₂, diode D₂, switch A_{f}, and capacitor C₂ as shown in FIG. 10F. Voltage Vₚ₂ of panel capacitor Cₚ₂ is reduced by the resonance path, and voltage Vₚ₁ of panel capacitor Cₚ₁ is maintained at 0V because switch A_{L1} is turned on. The current (energy) discharged from panel capacitor Cₚ₂ is supplied to capacitor C₂, and capacitor C₂ is charged with a voltage.

In mode 7, switches A_{H2} and A_{L1} are turned off and switches A_{H1} and A_{L2} are turned off to apply the voltage 0V to panel capacitor Cₚ₂. Switch A_{f} is turned off and switch Aᵣ is turned on to form a resonance path through capacitor C₂, switch Aᵣ, diode D₁, inductor L₁, switch A_{H2}, and panel capacitor Cₚ₁ as shown in FIG. 10G. Current is supplied from capacitor. C₂ by the resonance path to increase voltage Vₚ₁ of panel capacitor Cₚ₁ and discharge the capacitor C₂. Voltage Vₚ₁ of panel capacitor Cₚ₁ does not exceed Vₐ because the body diode of switch Aₐ is turned on when voltage Vₚ₁ of panel capacitor Cₚ₁ exceeds Vₐ. The current remaining in inductor L₁ after the voltage of panel capacitor Cₚ₁ reaches Vₐ is freewheeled through the body diode of switch Aₐ.

In mode 8, switch Aᵣ is turned off and switch Aₐ is turned on to maintain voltage Vₚ₁ of panel capacitor Cₚ₁ at Vₐ as shown in FIG. 10H.

During modes 5 through 8 as described, the power recovery circuit 210 supplies the voltage Vₐ to the address electrode A₂ᵢ₋₁ through switch A_{H1} of the address selecting circuit 220₂ᵢ₋₁. The address electrode A₂ᵢ is maintained at 0V through switch A_{L2} of the address selecting circuit 220₂ᵢ. The dot on/off pattern is realized by repeating the operation of modes 1 to 8.

When capacitor C₂ is charged with a voltage Vₐ/2, and the capacitance of capacitor C₂ is large enough to function as a voltage source for supplying the voltage Vₐ/2 to capacitor C₂, panel capacitor Cₚ₁ or Cₚ₂ charged with the voltage Vₐ in mode 2 or 6 can be discharged to 0V by the LC resonance principle, and panel capacitor Cₚ₁ or Cₚ₂ discharged 0V in mode 3 or 7 can be charged to voltage Vₐ.

First, current (energy) is supplied to capacitor C₂ through inductor L₂ from the voltage source in mode 1, and panel capacitor Cₚ₁ is discharged to supply the current (energy) to capacitor C₂ in mode 2. In this way, capacitor C₂ is charged with energy to raise the voltage of capacitor C₂ by an amount ΔV1 in modes 1 and 2. Current is supplied from capacitor C₂ through inductor L₁ to increase the voltage of panel capacitor Cₚ₂, and the residual current is recovered to the voltage source in mode 3. In this way, energy is discharged from capacitor C₂ to reduce the voltage of capacitor C₂ by the amount ΔV2. Assuming that capacitor C₂ is charged with the voltage Vₐ/2 in the earlier stage, the charge energy of capacitor C₂ is greater than discharge energy of capacitor C₂ because energy is further supplied through the voltage source in mode 1 at the time of charging capacitor C₂. Hence, ΔV1 is greater than ΔV2. The charge and discharge energy to and from the capacitor C₂ in modes 5 to 8 corresponds to the charge and discharge energy in modes 1 to 4. Because the panel capacitor Cₚ₁ or Cₚ₂ is discharged so that its residual voltage reaches 0V, and because the panel capacitor is charged again in mode 3 or 7, the energy discharged from the capacitor C₂ for charging the panel capacitor Cₚ₁ or Cₚ₂ is substantially constant when modes 1 to 8 are repeated.

When the charge energy of capacitor C₂ is greater than discharge energy thereof, and the voltage at capacitor C₂ increases, the energy charged into capacitor C₂ is reduced in modes 1 and 2 or modes 5 and 6. Thus, when the operations of modes 1 to 8 are repeatedly performed, the charge energy of capacitor C₂ is reduced, and the charge energy of capacitor C₂ and the discharge energy thereof finally become the same and thus reach an equilibrium state. The voltage charged in capacitor C₂ is greater than Vₐ/2 and less than Va.

When the voltage charged in panel capacitor C₂ is greater than Vₐ/2, a voltage equal to twice the voltage of the capacitor C₂, which therefore is greater than Vₐ, can be charged in panel capacitors Cₚ₁ and Cₚ₂ by the resonance principle in modes 3 and 7. Therefore, the voltages of panel capacitors Cₚ₁ and Cₚ₂ can rise to the voltage Vₐ by the resonance principle when a parasitic component is provided in the address driving circuit, and switch Aₐ can perform a zero-voltage switching operation.

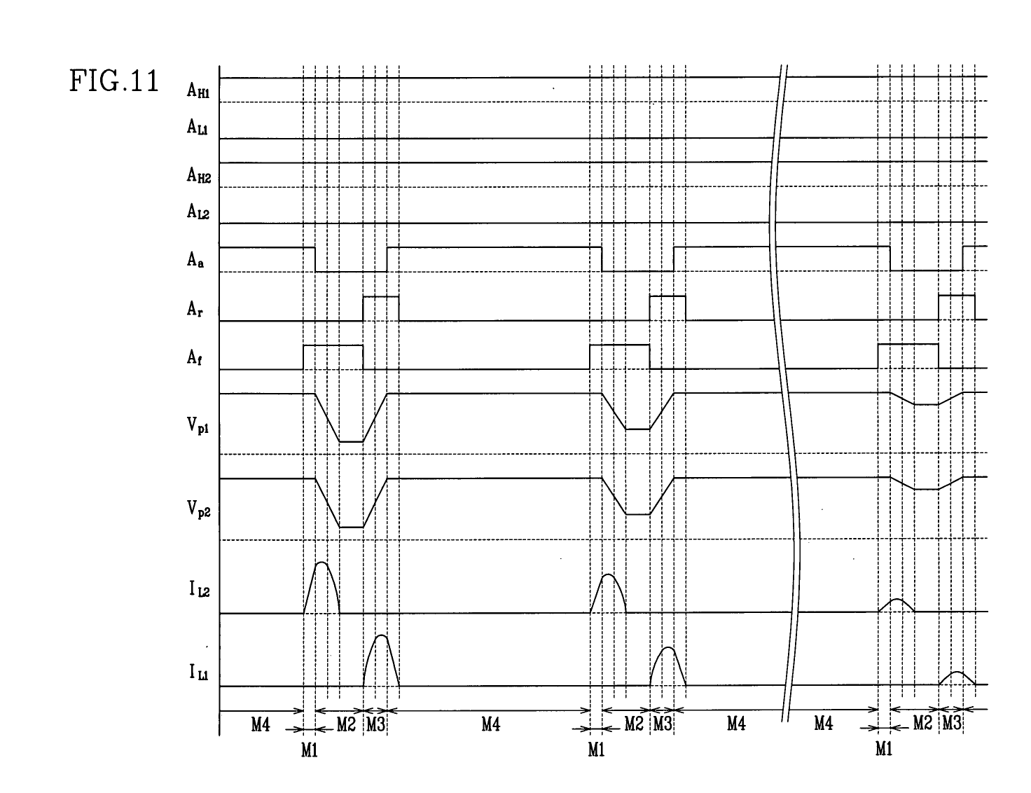

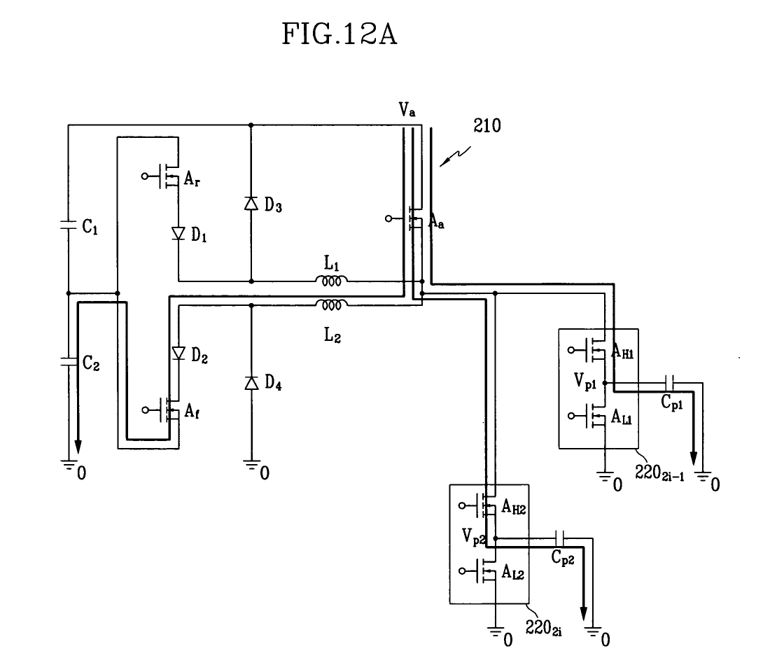

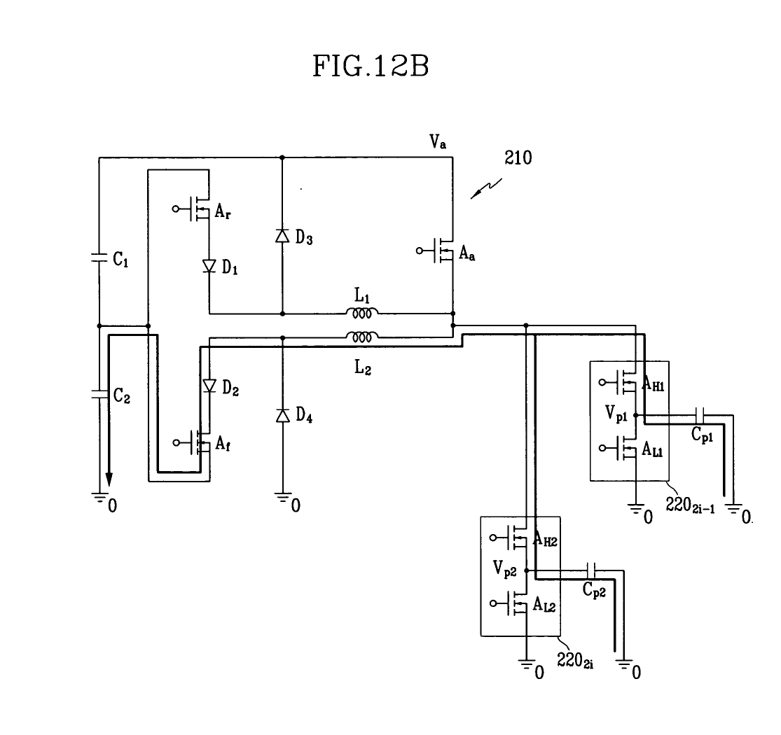

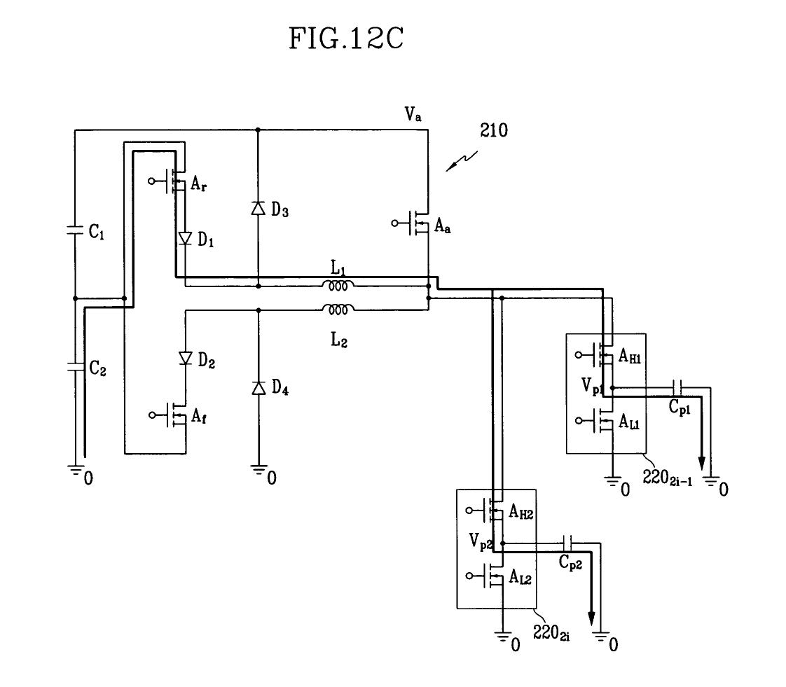

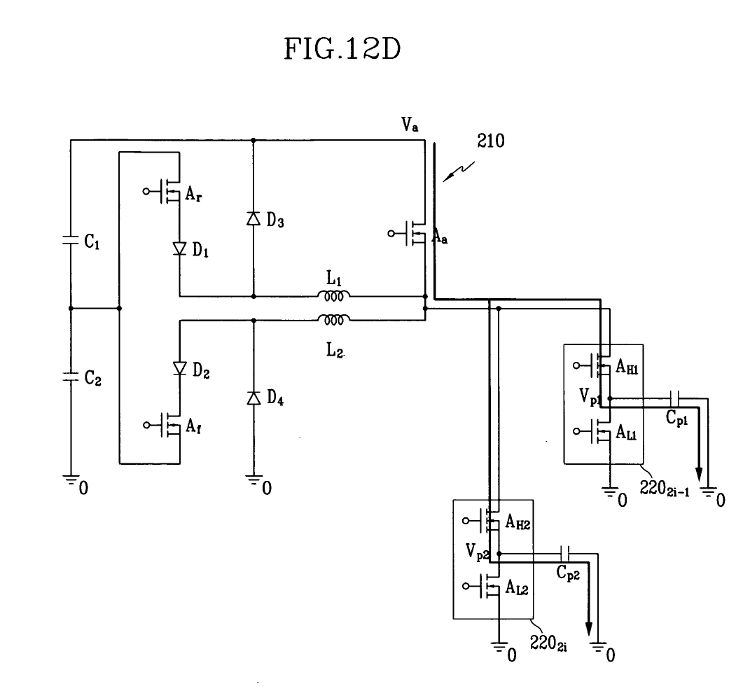

2. Full white pattern (Refer to FIGS. 11, and 12A to 12D)

A temporal operation of the address driving circuit for displaying a pattern with less switching variations of the address selecting circuits 220₁ to 220ₘ than in the line on/off pattern case will be described with reference to FIGS. 11 and 12A to 12D. The operation has four sequential modes, and the modes are varied by a manipulation of the switches. A resonance phenomenon arises but is not a continuous oscillation. Instead, it is a voltage and current variation caused by combination of an inductor L₁ or L₂ and a panel capacitor Cₚ₁ or Cₚ₂ when switches Aᵣ and A_{f} are turned on.

FIG. 11 shows a timing diagram of a power recovery circuit of FIG. 5 for showing the full white pattern, and FIGS. 12A to 12D show current paths for respective modes of the address driving circuit of FIG. 5 following the timing of FIG. 11.

In the case of displaying the full white pattern in the circuit of FIG. 5, switches A_{H1} and A_{H2} of the address selecting circuits 220₂ᵢ₋₁ and 220₂ᵢ are always turned on as the scan electrodes are sequentially selected.

It is assumed in FIG. 11 that switches A_{H1}, A_{H2}, and Aₐ are turned on before mode 1 begins so that the voltage Vₐ is applied to panel capacitors Cₚ₁ and Cₚ₂.

In mode 1, switch Aᵣ is turned on while switches A_{H1}, A_{H2}, and Aₐ are turned on. As shown in FIG. 12A, current is injected into inductor L₂ and capacitor C₂ to charge capacitor C₂ with a voltage in the same manner as mode 1 FIG. 9.

In mode 2, switch Aₐ is turned off to form a resonance path through panel capacitors Cₚ₁, and Cₚ₂, the body diodes of switches A_{H1} and A_{H2}, inductor L₂, diode D₂, switch A_{f}, and capacitor C₂ as shown in FIG. 12B. Voltages Vₚ₁ and Vₚ₂ of panel capacitors Cₚ₁ and Cₚ₂ are reduced by the resonance path, and capacitor C₂ is charged with a voltage in the same manner as in mode 2 of FIG. 9.

In mode 3, switch A_{f} is turned off and switch Aᵣ is turned on to form a resonance path through capacitor C₂, switch Aᵣ, diode D₁, inductor L₁, switch A_{H2}, and panel capacitors Cₚ₁ and Cₚ₂ as shown in FIG. 12C. Voltages Vₚ₁ and Vₚ₂ of panel capacitors Cₚ₁ and Cₚ₂ are increased by the resonance path, and capacitor C₂ is discharged. Voltages Vₚ₁ and Vₚ₂ of panel capacitors Cₚ₁ and Cₚ₂ do not exceed the voltage Vₐ because the body diode of switch Aₐ is turned on when voltages Vₚ₁ and Vₚ₂ exceed Va.

In mode 4, switch Aᵣ is turned off and switch Aₐ is turned on to maintain voltages Vₚ₁ and Vₚ₂ of panel capacitors Cₚ₁ and Cₚ₂ at Vₐ as shown in FIG. 12D.

During the modes 1 through 4, the power recovery circuit 210 supplies the voltage Vₐ to the address electrodes A₂ᵢ₋₁ and A₂ᵢ through switches A_{H1} and A_{H2} of the address selecting circuits 220₂ᵢ₋₁ and 220₂ᵢ as described. In the case of displaying the full white pattern of FIG. 9, modes 1 to 4 are repeated while switches A_{H1} and A_{H2} are turned on.

Because switches A_{L1} and A_{L2} of the address electrodes A₂ᵢ₋₁ and A₂ᵢ are not turned on in the full white pattern of FIG. 8, the residual voltages in panel capacitors Cₚ₁ and Cₚ₂ are not discharged. However, panel capacitors Cₚ₁ and Cₚ₂ are charged in mode 3 while the residual voltage is not discharged after panel capacitors Cₚ₁ and Cₚ₂ are discharged in mode 2. Therefore, assuming that 100% of the energy is recovered and used, the energy of charging capacitor C₂ in mode 2 and the energy discharged from capacitor C₂ in mode 3 are substantially the same. The voltage ΔV1 charged in capacitor C₂ is always greater than the voltage ΔV2 discharged from capacitor C₂ in the case of displaying the full white pattern of FIG. 8 because the operation of supplying current to capacitor C₂ to charge capacitor C₂ in mode 1 is further performed.

The voltage of capacitor C₂ is increased when the processes of modes 1 through 4 are repeated in the case where the voltage Δ V1 charged in capacitor C₂ is always greater than the voltage ΔV2 discharged from capacitor C₂. When the voltage of capacitor C₂ is increased, the current discharged from panel capacitors Cₚ₁ and Cₚ₂ to capacitor C₂ is reduced in mode 2 to reduce the discharged amount from panel capacitors Cₚ₁ and Cₚ₂. That is, the reducing amounts of voltages Vₚ₁ and Vₚ₂ of the panel capacitors Cₚ₁ and Cₚ₂ decrease as modes 1 to 4 are repeated as shown in FIG. 11.

When the voltage of capacitor C₂ is continuously increased to substantially correspond to the voltage Vₐ, panel capacitors Cₚ₁ and Cₚ₂ are not discharged in mode 2 because voltages Vₚ₁ and Vₚ₂ of panel capacitors Cₚ₁ and Cₚ₂ correspond to the voltage at capacitor C₂. Panel capacitors Cₚ₁ and Cₚ₂ are not charged in mode 3 because voltages Vₚ₁ and Vₚ₂ of panel capacitors Cₚ₁ and Cₚ₂ are not reduced in mode 2. When the voltage at capacitor C₂ reaches Vₐ, substantial current movement almost disappears in modes 2 and 3, and thus the power recovery circuit 210 essentially does not operate in the case of displaying the full white pattern.

As described above, the operation of the power recovery circuit according to the first exemplary embodiment of the present invention is established when the voltage level of capacitor C₂ is varied by the switching operation of the address selecting circuit. The voltage of capacitor C₂ is determined by the energy charged in and discharged from capacitor C₂. Because the charge energy of capacitor C₂ includes the energy supplied by the voltage source through an inductor and the discharge energy of the panel capacitor, and because the discharge energy of capacitor C₂ includes the charge energy of the panel capacitor, the charge energy of capacitor C₂ is greater than the discharge energy thereof when capacitor C₂ is charged with a voltage equal to Vₐ/2, which is half of the address voltage.

In the case of the dot on/off pattern, because the panel capacitor charged up to the address voltage is completely discharged down to the ground voltage and charged again up to the address voltage by the turn-on of switch A_{L} of the address selecting circuit, the charge energy of the panel capacitor, which is the discharge energy of capacitor C₂, is almost constant. In addition, the voltage at capacitor C₂ is increased, and the charge energy of capacitor C₂ is accordingly reduced because the charge energy of capacitor C₂ is greater than the discharge energy thereof while the capacitor C₂ is charged with a voltage Vₐ/2. Therefore, when the above operation is repeated, the charge energy of capacitor C₂ is reduced to correspond substantially to the discharge energy of capacitor C₂, thereby performing the power recovery operation.

Because of many switching variations of the address selecting circuits 220₁ to 220ₘ, capacitor C₂ is charged with a voltage between Vₐ/2 and Vₐ to thus perform the power recovery operation when many panel capacitors that are charged up to the address voltage after being completely discharged down to the ground voltage are provided from among a plurality of panel capacitors connected to the address selecting circuits 220₁ to 220ₘ.

In the case of the full white pattern, switch A_{L}, which is connected to the panel capacitor charged up to the address voltage, is not turned on. When the charge energy of capacitor C₂ is greater than its discharge energy so that the voltage at capacitor C₂ exceeds Vₐ/2, the voltage of the panel capacitor is not discharged down to the ground voltage by the resonance of the inductor and the panel capacitor. A residual voltage is generated because the switch A_{L} connected to the panel capacitor charged up to the address voltage is not turned on. The charge energy and the discharge energy of the panel capacitor are reduced in the same manner by the residual voltage, and accordingly, the voltage at capacitor C₂ is continuously increased. When the voltage at capacitor C₂ is increased, the residual voltage of the panel capacitor is also increased, almost no energy is charged in the panel capacitor and discharged from the same, and almost no energy is exhausted in the power recovery circuit.

In addition to the full white pattern, the above-noted power recovery operation is rarely performed for a pattern wherein only one color is displayed on the whole screen or a pattern wherein the address voltage is continuously applied to a predetermined number of address electrodes.

In the above-described first exemplary embodiment of the present invention, the power recovery operation is performed in a pattern that, due to many switching variations of the address selecting circuit, requires the power recovery operation and no power recovery operation is automatically performed in a pattern that, due to few switching variations of the address selecting circuit, requires no power recovery operation.

As an example, it may be assumed for purposes of this description that in the driving circuit shown in FIG. 4, the whole panel capacitances in the dot on/off pattern, the line on/off pattern, and the full white pattern are about 169 nF, 217 nF, and 288 nF, respectively. With is that panel capacitance, if the capacitor C1 has a capacitance of 10 μF, the capacitor C2 has a capacitance of 10° F., the inductor L₁ has an inductance of 0.1 μH, the inductor L2 has an inductance of 0.1 μH, the address voltage Vₐ is 60-65V. As those of skill in the art will realize, the above is only one example of the characteristics of the components and the lengths of the periods in embodiments of the invention; components with other characteristics and periods of different lengths may be used.

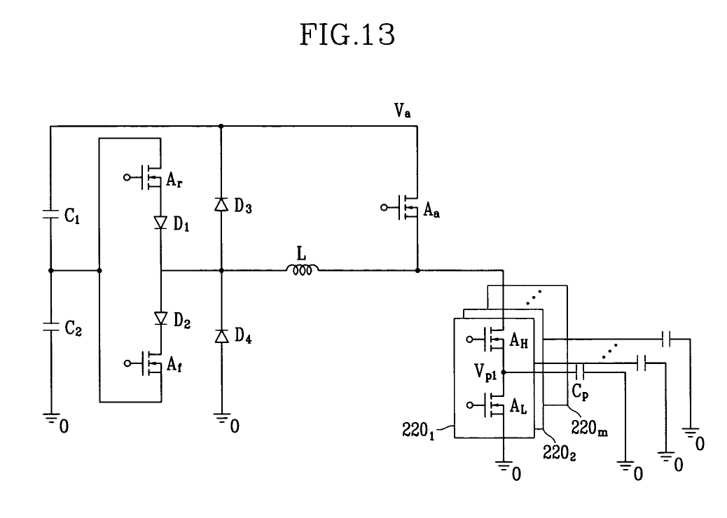

In the first exemplary embodiment, inductor L₁ used for discharging capacitor C₂ is different from inductor L₂ used for charging the capacitor C₂. However, the same inductor L can be used as shown in FIG. 13. A first terminal of inductor L is connected to a second terminal of switch A_{H} of the address selecting circuit 220₁ to 220ₘ, and a second terminal of inductor L is connected in parallel to diodes D₁ and D₂. Accordingly, the current charged in capacitor C₂ and the current therefrom flow through inductor L.

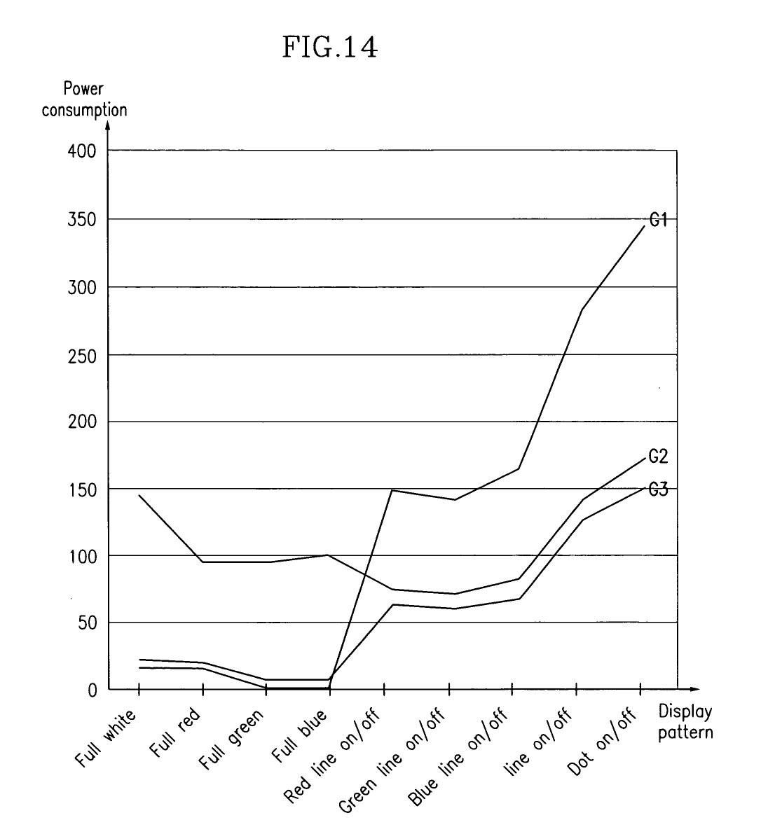

FIG. 14 shows the power consumption in the address driving circuit according to the first exemplary embodiment of the present invention. As shown in FIG. 14, in a pattern having many switching variations, such as the dot on/off pattern and the line on/off pattern, the power consumption G3 of the address driving circuit according to the first exemplary embodiment is lower than that G1 of a driving circuit that does not have the power recovery circuit, and is the same as that G2 of the conventional power recovery circuit (disclosed in U.S. Pat. Nos. 4,866,349 and 5,081,400). In addition, in a pattern having less switching variations such as the full white pattern, the full red pattern, the full green pattern and the full blue pattern, the power consumption G3 of the address driving circuit according to the first exemplary embodiment is lower than that G2 of the conventional power recovery circuit. However, in a pattern having less switching variations, the power consumption G3 of the address driving circuit is according to the first exemplary embodiment is higher than that G1 of a driving circuit that does not have the power recovery circuit because it performs a power recovery operation in this pattern.

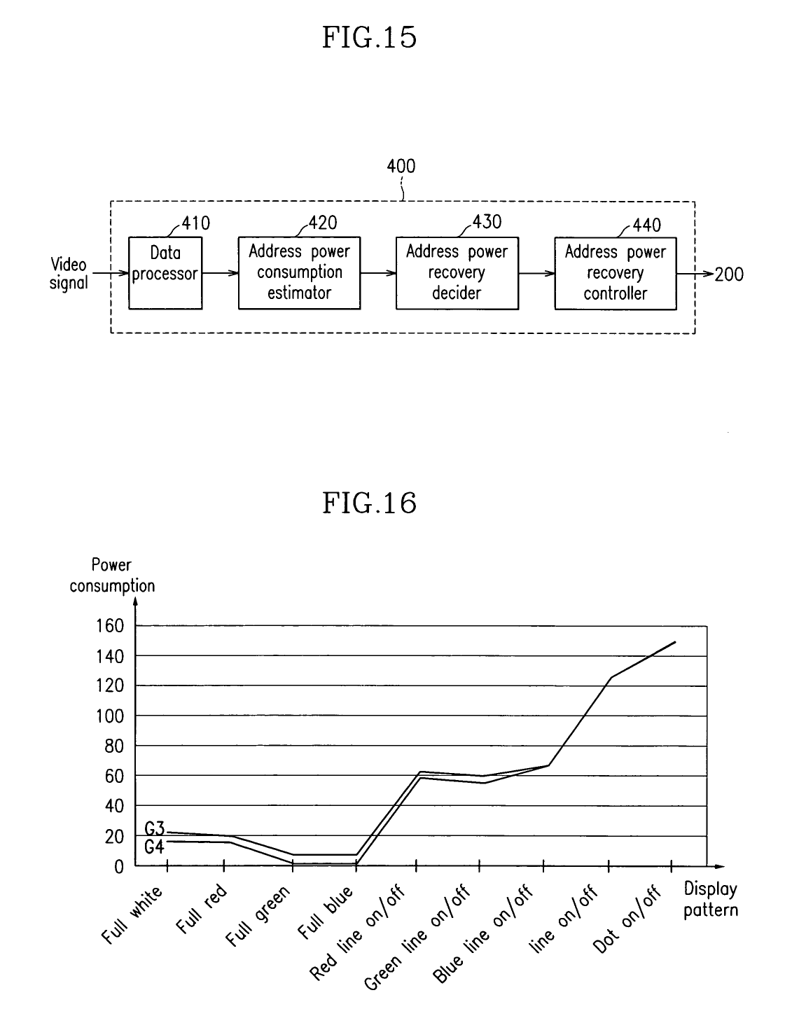

An exemplary embodiment having lower power consumption than that of the first exemplary embodiment will now be described with reference to FIGS. 15 and 16.

FIG. 15 shows a controller of a plasma display device according to a third exemplary embodiment of the present invention, and FIG. 16 shows the power consumption of the driving circuit according to the third exemplary embodiment of the present invention.

The plasma display device according to the third exemplary embodiment of the present invention has the controller 400 that is different from that of the plasma display device according to the first embodiment. Referring to FIG. 15, controller 400 of the plasma display device according to the third exemplary embodiment includes a data processor 410, an address power consumption estimator 420, an address power recovery decider 430, and an address power recovery controller 440.

The data processor 410 converts the inputted video signal to the on/off data in the respective subfields. Assuming that one frame (i.e., one TV field) is divided into eight subfields that have weights of 1, 2, 4, 8, 16, 32, 64 and 128 as the lengths of the sustain periods, respectively, the data processor 410 converts (for example) a video signal of 100 gray levels to 8 bits data of “00100110”. The bits “0” and “1” in the “00100110” respectively correspond to on and off states of the eight subfields 1SF to 8SF in the discharge cell (dot). A “0” indicates that the discharge cell will be not discharged (off) in the corresponding subfield, and a “1” indicates that the discharge cell (dot) will be discharged (on) in the corresponding subfield.

The address power consumption estimator 420 estimates the address power consumption in respective subfields from the video signal converted to on/off data. The address power consumption is determined by the switching variations of the address select circuits 220₁ to 220ₘ. Switching variation occurs when one of the two adjacent discharge cells in the column direction is on and the other is off. Therefore, as described in Equation 1, the address power consumption AP can be estimated from the total summation of the difference between the on/off data of two adjacent discharge cells in the column direction.

$$AP = {\sum }_{i = 1}^{n - 1} {\sum }_{j = 1}^{m} ( \vert {R}_{ij} - {R}_{( i + 1 )} \vert + \vert {G}_{ij} - {G}_{( i + 1 ) j} \vert + \vert {B}_{ij} - {B}_{( i + 1 ) j} \vert ) \qquad Equation 1$$

where Rᵢⱼ, Gᵢⱼ and Bᵢⱼ are the on/off data of the R (red), G (green) and B (blue) discharge cell in i-th row and j-th column, respectively.

Generally, because the video signal is serially inputted in the order of rows, the address power consumption estimator 420 includes a line memory (not shown) for storing the video signal of one row in order to calculate the difference between the on/off data of two adjacent discharge cells in the column direction. When the on/off data of the respective subfields for the video signal of one row are inputted, the address power consumption estimator 420 stores these on/off data to the line memory, reads the on/off data for the previous row from the line memory, and calculates the difference between the on/off data of two adjacent discharge cells in the respective subfields. The address power consumption estimator 420 performs this calculation with respect to all discharge cells and estimates the address power consumption AP from the summation of the calculation results. In addition, the address power consumption estimator 420 may perform an XOR (exclusive OR) operation between the on/off data of two adjacent discharge cells in the respective subfields instead of calculating the difference between the on/off data.

The address power recovery decider 430 uses the address power consumption AP calculated through Equation 1 to decide whether the power recovery operation is performed and outputs a control signal that indicates whether the power recovery operation should be performed. The address power recovery decider 430 outputs the control signal that indicates that the power recovery operation should be performed when the address power consumption AP is higher than the critical value, and outputs the control signal that indicates the power recovery operation should be not performed when the address power consumption AP is lower than the critical value.

The address power recovery controller 440 allows the power recovery circuit 210 described in the first or the second exemplary embodiment to operate when the control signal indicates that the power recovery operation should be performed. The address power recovery controller 440 prevents the power recovery circuit 210 described in the first or the second exemplary embodiment from operating when the control signal indicates that the power recovery operation should be not performed. To stop the power recovery operation, the address power recovery controller 440 always turns off switches Aᵣ and A_{f} and turns on switch Aₐ so that the voltage Vₐ is applied to the first terminals of switches A_{H} of the address selecting circuits 220₁ to 220ₘ. Then, the addressing voltage Vₐ is applied to the address electrodes A₁ to Aₘ by only turning on switch AH. Therefore, the power consumption by the resonance generated when switch Aᵣ or A_{f} is turned on is removed.

In the third exemplary embodiment of the present invention, because switches Aᵣ and A_{f} of the power recovery circuit 210 are always turned on in a display pattern having less switching variations, switching loss from the operation of switches Aᵣ and A_{f} and the power consumption by the resonance generated when switch Aᵣ or A_{f} is turned on can be removed. Therefore, as shown in FIG. 16, the power consumption of the third exemplary embodiment is lower than that of the first exemplary embodiment in a pattern having less switching variations, such as the full white pattern, the full red pattern, the full green pattern and the full blue pattern.

In the third exemplary embodiment of the present invention, the address power consumption is determined by whether two adjacent discharge cells in the column direction are on or not. However, the address power consumption is also affected by the adjacent discharge cells in the row direction. A fourth exemplary embodiment for controlling the operation of the power recovery circuit 210 while accounting for the adjacent discharge cells in the row direction will be described.

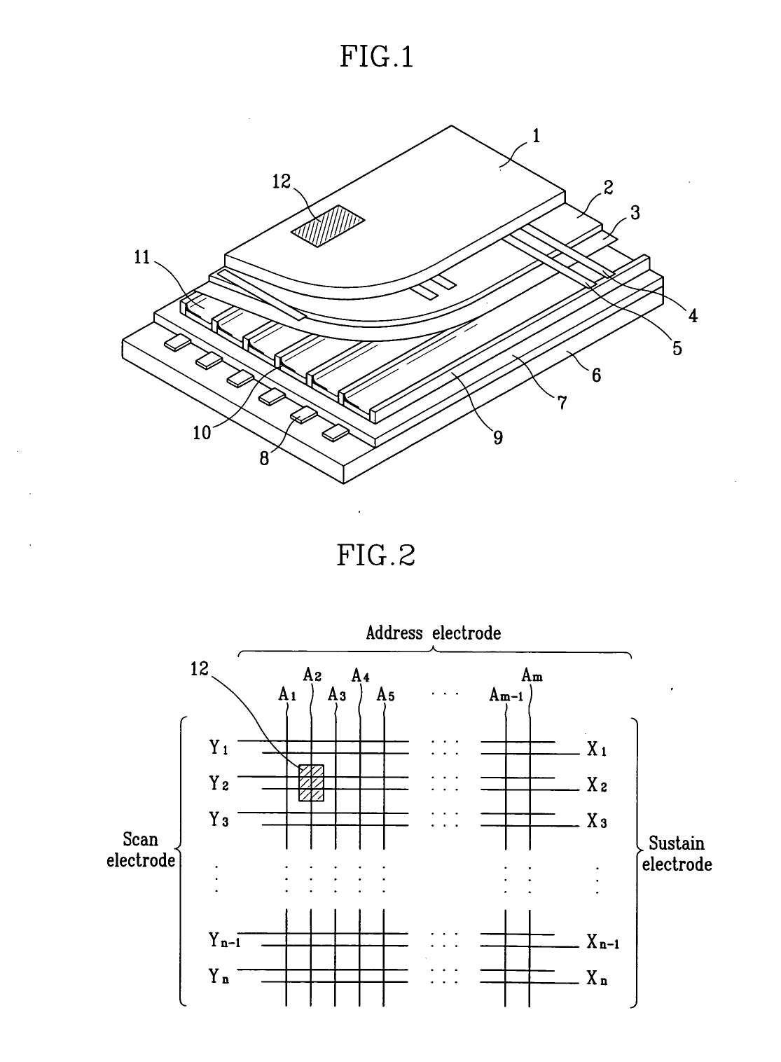

As shown in FIGS. 1 to 3, the capacitance component exists between the two adjacent address electrodes Aᵢ and Aᵢ₊₁ because the address electrodes A₁ to Aₘ are extended in a column direction. Therefore, power consumption in the case when the voltages applied to the two adjacent address electrodes Aᵢ and Aᵢ₊₁ are the same is lower than in of the case when the voltages applied to the two adjacent address electrodes Aᵢ and Aᵢ₊₁ are different. Hence, power consumption in the dot on/off pattern shown in FIG. 6 is higher than in the line on/off pattern shown in FIG. 7.

In detail, the capacitance between the two adjacent address electrodes Aᵢ and Aᵢ₊₁ in the row direction increases when the on/off states of the adjacent discharge cells in the row direction are different. Then, the reactive power for injecting charges in the capacitance increases since the total capacitances loaded on the power recovery circuit of the address driving circuit increase when the capacitance formed in the row direction increases. On the contrary, the capacitance between the two adjacent address electrodes Aᵢ and Aᵢ₊₁ decreases when the on/off states of the adjacent discharge cells in the row direction are the same. In this case, the total capacitances loaded on the power recovery circuit decrease so that the reactive power decreases.

In the third exemplary embodiment, the operation of the power recovery circuit is determined by the on/off states of the adjacent discharge cells in the row direction because the reactive power consumption is different according to the on/off states of the adjacent discharge cells in the row direction. As shown in Equation 2, the address power consumption AP is determined by the difference of the on/off data between adjacent discharge cells in the row direction as well as that between adjacent discharge cells in the column direction. In Equation 2, it is assumed that the discharge cells are repeated in order of R, G and B in the row direction.

$$AP = {\sum }_{i = 1}^{n - 1} {\sum }_{j = 1}^{m} ( \vert {R}_{ij} - {R}_{( i + 1 )} \vert + \vert {G}_{ij} - {G}_{( i + 1 ) j} \vert + \vert {B}_{ij} - {B}_{( i + 1 ) j} \vert ) + {\sum }_{i = 1}^{n} {\sum }_{j = 1}^{m} ( \vert {R}_{ij} - {G}_{ij} \vert + \vert {G}_{ij} - {B}_{ij} \vert + \vert {B}_{ij} - {R}_{i ( j + 1 )} \vert ) \qquad Equation 2$$

As described above, in the third and fourth exemplary embodiments of the present invention, the power recovery operation does not occur for a pattern having less switching variations so that power consumption is reduced.

In addition, according to the present invention, the power recovery operation is performed for a pattern with many switching variations of the address selecting circuit, and the power recovery operation is automatically prevented in a pattern without switching variations of the address selecting circuit, thereby reducing the power consumption. Zero-voltage switching is performed when the address voltage is applied because an external capacitor is charged with a value greater than half of a predetermined voltage.

A similar invention is described in the patent application, filed together with this application and assigned to the same assignee, entitled “PLASMA DISPLAY PANEL DRIVER, DRIVING METHOD THEREOF, AND PLASMA DISPLAY DEVICE”, application Ser. No. ______, which is incorporated by reference.

While this invention has been described in connection with what is presently considered to be the most practical and exemplary embodiment, it is to be understood that the invention is not limited to the disclosed embodiments, but, on the contrary, is intended to cover various modifications and equivalent arrangements included within the spirit and scope of the appended claims.

1. A plasma display device comprising:
a panel including a plurality of first electrodes extending in a first direction and a plurality of second electrodes extending in a second direction intersecting the first direction;
a first driving circuit sequentially applying a first voltage to the first electrodes;
a selecting circuit coupled to the second electrodes, for selecting second electrodes to which a second voltage will be applied from among the second electrodes;
a second driving circuit including at least one inductor having a first terminal coupled to the selecting circuit, and a capacitor coupled to a second terminal of the inductor, for applying the second voltage to the second electrode selected by the selecting circuit; and
a controller deciding an operating mode of second driving circuit in response to a video signal,
wherein when the operating mode is a first mode, the second driving circuit applies the second voltage to the selected second electrode after charging a capacitive load formed by the first electrode and the selected second electrode through the capacitor and the inductor, and discharges the capacitive load through the capacitor and the inductor, thereby reducing the voltage of the selected second electrode, and a residual voltage after the capacitive load is discharged is reduced by an operation of the selecting circuit; and
the second driving circuit directly applies the second voltage to the selected second electrode when the operating mode is a second mode.

2. The device of claim 1, wherein the controller decides the operating mode to be the first mode when the number of first discharge cells is more than a predetermined value in at least one subfield, the on/off state of the first discharge cell being different from that of the discharge cell adjacent to the first discharge cell in the first direction.

3. The device of claim 1, wherein the controller decides the operating mode to be the first mode when a summation of the number of first discharge cells and the number of second discharge cells is more than a predetermined value in at least one subfield, the on/off state of the first discharge cell being different from that of the adjacent discharge cell in the first direction, and the on/off state of the second discharge cell being different from that of the adjacent discharge cell in the second direction.

4. The device of claim 1, wherein the second driving circuit supplies a current to the capacitor before discharging the capacitive load in the first mode.

5. The device of claim 4, wherein the current supplied to the capacitor is supplied from the voltage source supplying the second voltage.

6. The device of claim 4, wherein in the first mode, the second driving circuit operates in the order of:
a first period during which the capacitive load is charged through the inductor and the voltage charged in the capacitor;
a second period during which the selected second electrode of the capacitive load is substantially maintained at the second voltage through the voltage source supplying the second voltage;
a third period during which a current is supplied to the inductor and the capacitor by using the voltage source; and
a fourth period during which the capacitive load is discharged by using the voltage charged in the capacitor and the inductor.

7. The device of claim 4, wherein the second driving circuit further comprises:
a first switch and a second switch coupled between the second terminal of the inductor and the capacitor or between the first terminal of the inductor and the selecting circuit in parallel; and
a third switch coupled between a voltage source supplying the second voltage and the selecting circuit.

8. The device of claim 7, wherein the first switch, the second switch and the third switch respectively are transistors including a body diode, and
the second driving circuit further comprises a first diode formed in the opposite direction of the body diode of the first switch in the path formed by the capacitor, the first switch, and the inductor; and a second diode formed in the opposite direction of the body diode of the second switch in the path formed by the capacitor, the second switch, and the inductor.

9. The device of claim 8, wherein in the first mode, the second driving circuit operates in the order of:
a first period during which the first switch is turned on,
a second period during which the third switch is turned on,
a third period during which the second switch and the third switch are turned on, and
a fourth period during which the second switch is turned on.

10. The device of claim 7, wherein in the second mode, the first switch is turned on, and the second switch and the third switch are turned off.

11. The device of claim 1, wherein the at least one inductor includes a first inductor and a second inductor, and
in the first mode, the second driving circuit charges the capacitive load through the first inductor and discharges the capacitive load through the second inductor.

12. The device of claim 1, wherein the inductor on the path of charging the capacitive load is the same as the inductor on the path of discharging the capacitive load.

13. The device of claim 1, wherein the selecting circuit includes a plurality of first switches respectively coupled between the second electrodes and the first terminal of the inductor, and a plurality of second switches respectively coupled between the second electrodes and a voltage source for supplying a third voltage.

14. The device of claim 13, wherein the discharge cells to be turned on are selected by the second electrode coupled to the turned-on first switch and the first electrode to which the first voltage is applied.

15. The device of claim 13, wherein the second driving circuit operates in the second mode when the first switches of the selecting circuit are continuously turned on while the first voltage is sequentially applied to the first electrodes.

16. The device of claim 1, wherein the capacitor is charged with a voltage between half of the second voltage and the second voltage.

17. The device of claim 16, wherein the voltage of the capacitor is variable in the first mode.

18. A driving method of a plasma display panel on which a plurality of first electrodes and second electrodes are formed, a capacitive load being formed by the first and second electrodes, the driving method comprising:
deciding operating modes in the respective subfields from a video signal; and
selecting the first electrodes to which a first voltage will be applied among the first electrodes, and applying a second voltage to the first electrodes that are not selected,
wherein when the operating mode is a first mode, the driving method further comprises:
increasing a voltage of the selected first electrode through a first inductor having a first terminal coupled to the first electrode;
substantially maintaining a voltage of the selected first electrode at the first voltage through a first voltage source supplying the first voltage;
supplying a current to a second inductor having a first terminal coupled to the first electrode while substantially maintaining a voltage of the selected first electrode at the first voltage; and
reducing the voltage of the selected first electrode through the second inductor, and
when the operating mode is a second mode, the driving method further comprises applying the first voltage to the first electrode selected through the first voltage source.

19. The driving method of claim 18, wherein a discharge cell is formed by the first electrode and the second electrode, and the operating mode is decided to be the first mode when the number of first discharge cells is more than a predetermined value in at least one subfield, the on/off state of the first discharge cell being different from that of the discharge cell adjacent to the first discharge cell in a direction where the first electrode extends.

20. The driving method of claim 18, wherein a discharge cell is formed by the first electrode and the second electrode, and the operating mode is decided to be the first mode when a summation of the number of first discharge cells and the number of second discharge cells is more than a predetermined value in at least one subfield, the on/off state of the first discharge cell being different from that of the adjacent discharge cell in a direction where the first electrode extends, and the on/off state of the second discharge cell being different from that of the adjacent discharge cell in a direction where the second electrode extends.

21. The driving method of claim 18, wherein in the first mode, a capacitor is coupled to a second terminal of the first inductor and a second terminal of the second inductor when the voltage of the first electrode is increased and reduced.

22. The driving method of claim 21, wherein in the first mode, the capacitor is discharged when the voltage of the first electrode is increased through the first inductor, and the capacitor is charged when the current is supplied to the second inductor and the voltage of the first electrode is reduced through the second inductor.

23. The driving method of claim 22, wherein an energy discharged from the capacitor is less than an energy charged in the capacitor.

24. The driving method of claim 22, wherein the voltage stored in the capacitor corresponds to a voltage between half the first voltage and the first voltage.

25. The driving method of claim 18, wherein the first and second inductors are the same.

26. The driving method of claim 18, wherein the first and second inductors are different.

27. The driving method of claim 18, wherein a third voltage is sequentially applied to the second electrodes;
in the first mode, increasing a voltage of the first electrode selected through a first inductor having a first terminal coupled to the first electrode, substantially maintaining a voltage of the selected first electrode at the first voltage through a first voltage source supplying the first voltage, supplying a current to a second inductor coupled to the first electrode while substantially maintaining a voltage of the selected first electrode at the first voltage, and reducing the voltage of the selected first electrode through the second inductor are repeated each time the third voltage is applied to the second electrode; and
the voltage of the capacitor is varied according to a combination of a previously selected first electrode and a currently selected first electrode.

28. A plasma display device comprising:
a panel including a plurality of first electrodes extending in a first direction and a plurality of second electrodes extending in a second direction intersecting the first direction;
a first driving circuit sequentially applying a first voltage to the first electrodes;
a selecting circuit coupled to the second electrodes, for selecting second electrodes to which data will be applied among the second electrodes; and
a second driving circuit including at least one inductor coupled to the selecting circuit, and a capacitor coupled to the inductor,
wherein the second driving circuit electrically intercepts between the inductor and the capacitor and applies a second voltage to the second electrodes selected by the selecting circuit when a total summation of data difference between two discharge cells adjacent in the second direction in a predetermined number of discharge cells is less than a predetermined value; and
the second driving circuit charges and discharges a capacitive load formed by the second electrode selected by the selecting circuit and the first electrode by using the inductor and the capacitor, and applies the second voltage to the second electrode selected after charging the capacitive load when the total summation is more than the predetermined value.

29. The device of claim 28, wherein a residual voltage after the capacitive load is discharged is reduced by an operation of the selecting circuit; and

30. The device of claim 29, wherein the second driving circuit supplies a current to the capacitor through the inductor from a voltage source supplying the second voltage before discharging the capacitive load.

31. The device of claim 29, wherein an energy charged to the capacitor includes an energy discharged from the capacitive load and an energy supplied to the capacitor through the inductor from the voltage source, and an energy discharged from the capacitor includes an energy charging the capacitive load.

32. The device of claim 28, wherein the total summation is performed in one subfield.

33. A plasma display device comprising:
a panel including a plurality of scan electrodes extending in a first direction and a plurality of address electrodes extending in a second direction intersecting the first direction;
a first driving circuit sequentially applying a first voltage to the scan electrodes;
a selecting circuit coupled to the address electrodes, for selecting address electrodes to which data will be applied among the address electrodes;
a second driving circuit coupled to the address electrodes selected through the selecting circuit; and
a controller deciding an operating mode of the second driving circuit in response to a video signal,
wherein the second driving circuit includes: at least one inductor having a first terminal coupled to the address electrodes; a first switch coupled between a voltage source supplying an address voltage and the address electrodes; a capacitor coupled to a second terminal of the inductor; and at least one second switch coupled between the second terminal of the inductor and the capacitor or between the inductor and the selecting circuit,
when the operating mode is the first mode, the second driving circuit increases and reduces a voltage of the address electrode by on/off operation of the second switch, and a residual voltage after the voltage of the address electrode is reduced is reduced to a predetermined voltage by an operation of the selecting circuit; and
when the operating mode is the second mode, the second driving circuit electrically intercepts between the capacitor and the inductor by turning off the second switch.

34. The device of claim 33, wherein the controller decides the operating mode to be the first mode when the number of first discharge cells is more than a predetermined value in at least one subfield, the on/off state of the first discharge cell being different from that of the discharge cell adjacent to the first discharge cell in the first direction.

35. The device of claim 33, wherein in the first mode, the second driving circuit supplies a current to the capacitor through the inductor before reducing the voltage of the address electrode.

36. The device of claim 35, wherein in the first mode, the second driving circuit operates in the order of:
a first period during which the second switch is turned on,
a second period during which the first switch is turned on,
a third period during which the first switch and the second switch are turned on, and
a fourth period during which the second switch is turned on.

37. A plasma display device comprising:
a panel including a plurality of first electrodes extending in a first direction and a plurality of second electrodes extending in a second direction intersecting the first direction;
a first driving circuit sequentially applying a first voltage to the first electrodes;
a selecting circuit coupled to the second electrodes, for selecting second electrodes to which data will be applied among the second electrodes; and
a second driving circuit including at least one inductor coupled to the selecting circuit, and a capacitor coupled to the inductor,
wherein the inductor and the capacitor are electrically intercepted in a first operating mode, and the voltage of the capacitor is variable according to the display pattern in a second operating mode.

38. A plasma display device comprising:
a panel including a plurality of first electrodes extending in a first direction and a plurality of second electrodes extending in a second direction intersecting the first direction;
a first driving circuit sequentially applying a first voltage to the first electrodes;
a selecting circuit coupled to the second electrodes, for selecting second electrodes to which data will be applied among the second electrodes; and
a second driving circuit including at least one inductor coupled to the selecting circuit, and a capacitor coupled to the inductor,
wherein in a first operating mode the resonance between the inductor and the capacitor is not generated; and
in a second mode the resonance between the inductor and the capacitor is generated and the voltage of the capacitor is variable according to the display pattern.
